(19) United States
(12) Patent Application Publication
(10) Pub. No.: US 2025/0068914 A1
(43) Pub. Date: Feb. 27, 2025

(54) EFFICIENT TENSOR OPERATIONS USING SLICING

(71) Applicant: Expedera, Inc., Santa Clara, CA (US)

(72) Inventors: Suhail Ibrahim Alnahari, Merced, CA (US); Kai-Er Chuang, New Taipei City (TW); Siyad Chih-Hua Ma, Palo Alto, CA (US); Shang-Tse Chuang, Los Altos, CA (US); Sharad Vasantrao Chole, San Jose, CA (US)

(21) Appl. No.: 18/932,393

(22) Filed: Oct. 30, 2024

Related U.S. Application Data
(63) Continuation-in-part of application No. 17/504,488, filed on Oct. 18, 2021, now Pat. No. 12,182,717.
Application No. 17/504,488 is a continuation of application No. 16/568,195, filed on Sep. 11, 2019, now Pat. No. 11,151,416.

(51) Int. Cl. G06N 3/084; G06F 18/2115; G06F 18/214; G06N 3/04; G06V 10/44; G06V 10/764; G06V 10/82; G06V 20/00

(52) U.S. Cl. CPC G06N 3/084; G06F 18/2115; G06F 18/2148; G06N 3/04; G06V 10/454; G06V 10/764; G06V 10/82; G06V 20/00

(57) ABSTRACT

A system and method of performing tensor operations with a multi-step operation processing system in a memory-efficient manner. The method includes the stages of dividing an N-dimensional tensor into a set of tensor slices. The tensor slices consist of one or more consecutive rows. The tensor slices may further be segmented. The tensor slice segments, along with the dependency data, form based on the tensor dependencies are used for an tensor operation computation to generate a first result. Each processed slice segment is fused into a result slice by removing extra data used in the computation. This process is repeated for each slice to be processed and combined into a final processed tensor result.

### CROSS-REFERENCE TO RELATED APPLICATIONS

The present application is a continuation-in-part and claims priority benefit of U.S. patent application Ser. No. 17/704,488 filed Oct. 18, 2021. The U.S. patent application Ser. No. 17/704,488 is a continuation of U.S. patent application entitled “Method and Apparatus for Efficiently Processing Convolution Neural Network Operations” filed Sep. 11, 2019 having U.S. patent application Ser. No. 16/568,195.

The present invention relates to the field of artificial intelligence, digital image analysis and tensor processing. In particular, but not by way of limitation, the present invention discloses methods and apparatus for quickly and efficiently performing convolutional neural network computations.

### BACKGROUND

Artificial Intelligence is field of computer science that seeks to emulate the cognitive functions of a human mind. For example, artificial intelligence attempts to create computer systems that are capable of learning and problem solving. Many different techniques have been used to attempt to create useful artificial intelligence systems. Simple algorithms, heuristics, Bayesian networks, decision trees, support vector machines, and many other techniques have been used to obtain effective results in the field of artificial intelligence. However, at the present time one of the most popular techniques used in the field of artificial intelligence is the construction of artificial neural networks.

Artificial neural networks were originally designed based up the biological networks of neuron cells that are present within animal brains. Like biological brains, artificial neural networks operate by processing numerous input data elements (an input vector) to generate some sort of output inference just as human brains experience sights, sounds, and other sensory input from the world around them to generate inferences about that experience world. But, just like a newly born human infant, a brand new artificial neural network cannot make useful inferences until that artificial neural network has received a good amount of training.

Before an artificial neural network is useful in a particular application, that artificial neural network first must be trained. To train an artificial neural network, sets of training data are presented to the artificial neural network and the artificial neural networks processes the training data to generate an inference from the training data. The neural network generated inference is then compared with a desired answer to determine an error amount. That error amount is then used to adjust an internal weight matrix within the artificial neural network in order to improve the inference performance of the artificial neural network. This technique of making attempted inferences, comparing the generated inference to a desired correct result, and then adjusting various parameters within the artificial neural network accordingly is known as supervised learning. By training artificial neural networks with supervised learning with large amounts of training data, artificial neural networks can eventually become accurate at generating classification inferences that are very useful in various applications.

One increasingly popular application for artificial neural network learning is the task of image recognition and classification. With image recognition and classification, digital image data is presented to an artificial neural network system and the artificial neural network system is tasked with recognizing and classifying items within the presented digital image.

An artificial intelligence system designed for an image recognition and classification task can be extremely memory and computationally intensive. For example, consider the task of analyzing a conventional high-resolution image made up of 1920 by 1080 pixels wherein each individual pixel is made up of three different pixel color information values (red, green, and blue). That high-resolution digital image has 1920*1080*3=6,220,800 different data values that must be processed by the artificial neural network system. Furthermore, each individual pixel of the digital image will generally be involved in several different computations thus raising the number of computations exponentially. For full motion video artificial intelligence applications such as driving an autonomous vehicle, many individual digital video frames need to be processed each second. For example, with a 30 video frames per second system, 30*6,220,800=186,624,000 individual pixel data values must be processed by multiple computational operations each second just to perform the initial image processing and feature extraction tasks required for image recognition and classification.

In order to perform image recognition and classification, a convolutional neural network (CNN) may be used. A convolutional neural network operates in two phases: a feature extraction phase and a classification phase. The feature extraction phase of a convolutional neural network processes each digital image with a series of convolutional processing steps to extract important features from the source digital image. The feature extraction phase also reduces the amount of data into a smaller dense feature-rich data set. The feature rich data set is then processed during a classification phase in order to perform image recognition and classification.

The feature extraction phase of a convolutional neural network (CNN) generally comprises a repeated series of convolutional filter operations and pooling operations. The convolutional filter operations help extract features from the source digital image data. The pooling operations reduce the amount of data. The source digital image data may be processed by a long series of convolutional filter operations and pooling operations. Clearly, processing such large amounts of digital image pixel information in order to perform image recognition and classification very quickly becomes an extremely difficult computational task. Very large amounts of memory, memory bandwidth, and computational processing power are required to perform the series of feature extraction steps.

Although the feature extraction phase of a convolutional neural network may reduce the amount of data used in a later classification phase, all of the processing operations during the feature extraction phase of convolutional neural network generally require a very large amount memory storage, memory bandwidth, and processing power to process the digital image source data with feature extraction processing steps for later classification processing. It would therefore be desirable to identify and implement methods to most efficiently implement the feature extraction processing of a convolutional neural network.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a conceptual diagram of a simple two-layer artificial neural network.

FIG. 2 illustrates a conceptual diagram of the feature extraction steps for an example convolutional neural network.

FIG. 3A conceptually illustrates a small digital image, a convolutional filter, and an output array.

FIG. 3B conceptually illustrates a convolutional filter applied to the upper left corner of a digital image to generate an output value.

FIG. 3C conceptually illustrates the convolutional filter of FIG. 3B being applied to the digital image after striding over one pixel.

FIG. 3D conceptually illustrates a convolutional filter of FIG. 3C applied to the upper-right corner of the digital image after striding across the top rows of the digital image.

FIG. 3E conceptually illustrates the convolutional filter of FIG. 3B being applied to the digital image after striding down one pixel.

FIG. 3F conceptually illustrates a convolutional filter applied to the lower-right corner of the digital image after striding across the entire digital image.

FIG. 4A illustrates a conceptual diagram of a Max Pooling operation that may be used in a convolutional neural network.

FIG. 4B illustrates a conceptual diagram of a Mean Pooling operation that may be used in a convolutional neural network.

FIG. 5 illustrates a block diagram of feature extraction steps for an example convolutional neural network that includes five different convolutional steps and two pooling steps.

FIG. 6A illustrates a conceptual diagram of the feature extraction steps of the convolutional neural network of FIG. 2 wherein the original digital image source data has been divided into quadrants.

FIG. 6B illustrates digital image source data that has been divided into four overlapping quadrants.

FIG. 6C illustrates digital image source data that has been divided into sixteen overlapping areas.

FIG. 7A illustrates the cone of dependence of a single data value on the right being dependent on more and more data values from every earlier convolutional step.

FIG. 7B illustrates a cone of influence wherein a single data pixel on the left influences more and more data values in every successive convolutional step.

FIG. 8A illustrates a one-dimensional example of a first convolution operation on the first three data values in source data array with a convolutional filter creating a first intermediate data value in an intermediate array.

FIG. 8B illustrates the one-dimensional convolution example of FIG. 8A after processing the entire source data array to create a full set of intermediate data values in an intermediate array.

FIG. 8C illustrates the one-dimensional convolution example of FIG. 8B after processing an entire intermediate array to create another full set of intermediate data values in another intermediate array.

FIG. 8D illustrates the one-dimensional convolution example of Figure SC after processing an entire intermediate array to create a full set of final output data values in a final data array.

FIG. 9 illustrates a flow diagram of a cone of dependency based processing method for a convolutional neural network.

FIG. 10A to 10G illustrate cone of dependency processing of an example one-dimensional convolutional neural network.

FIG. 11 illustrates a flow diagram of a cone of influence based processing method for a convolutional neural network.

FIG. 12A to 12C illustrate cone of dependency processing of an example one-dimensional convolutional neural network.

FIG. 13A conceptually illustrates a digital image being convolutional processed both from top to bottom and from bottom to top.

FIG. 13B conceptually illustrates a digital image of FIG. 13A wherein the two convolutional processing tasks have met in the center of the image.

FIG. 13C illustrates an expanded slice from the digital image illustrated in FIG. 13A.

FIG. 14A conceptually illustrates a digital image being convolutional processed by six independent convolutional processing tasks.

FIG. 14B conceptually illustrates a digital image of FIG. 14A wherein the six convolutional processing tasks have completed.

FIG. 15A conceptually illustrates transform operations on a pair of three channel images being divided into slices for a convolution computation generating processed slices.

FIG. 15B conceptually illustrates transform operations on a pair of three channel images by a convolution computation.

FIG. 15C conceptually illustrates the slices of a pair of images being processed by a convolution that does not have data dependencies beyond each slice.

FIG. 16 conceptually illustrates the convolutional computation of two images that have data dependencies between slices.

FIG. 17 conceptually illustrates the convolution computation 1 through NHY, with no data dependencies between the slice segments, reconstructed into the result convolution slices.

FIG. 18 conceptually illustrates the overlap between adjacent slice segments.

FIG. 19 conceptually illustrates the convolution computation of a tensor slice segments through two convolution computations and fused back into a final results slice.

FIG. 20A shows a sentence that can be tokenized.

FIG. 20B shows the sentence of FIG. 1A tokenized into tokens.

FIG. 21 shows a block diagram of the Input Embedding of tokens generating input vectors.

FIG. 22 shows a block diagram of multi-headed attention processing.

FIG. 23A shows the attention formulas.

FIG. 23B shows the attention formulas for a 4-dimension image.

FIG. 23C is an attention processing flow diagram of the tensors to generate an attention output.

FIG. 23D is an attention processing flow diagram includes matrix dimensions for the Q, K, and V tensors and the attention tensor.

FIG. 23E is an attention processing flow diagram for where the Q feature vector has been divided into two processing paths.

FIG. 23F is n attention block diagram of where the Value feature vector has been split into two processing paths.

FIG. 23G is a block diagram of the eight processing paths for computing an attention output split on independent dimensions of the row, Query, and Value processing paths.

FIG. 24 is a diagram of a tensor processing system using NPU processors.

### DETAILED DESCRIPTION

The following detailed description includes references to the accompanying drawings, which form a part of the detailed description. The drawings show illustrations in accordance with example embodiments. These embodiments, which are also referred to herein as “examples,” are described in enough detail to enable those skilled in the art to practice the invention. It will be apparent to one skilled in the art that specific details in the example embodiments are not required in order to practice the present invention. For example, although some of the example embodiments are disclosed with reference to specific convolutional neural network embodiments, the techniques may be used with other implementations of convolutional neural networks. The example embodiments may be combined, other embodiments may be utilized, or structural, logical and electrical changes may be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

### Neural Networks Overview

Artificial neural networks (ANNs) are increasingly being used to perform many difficult reasoning tasks. Artificial neural networks were originally designed to mimic the biological networks of neuron cells employed within animal brains. Like biological brains, artificial neural networks learn from the experience of input data from the world around them and adjust internal parameters accordingly. For artificial neural networks, sets of training data are presented to the artificial neural network and the artificial neural networks attempts to make an inference. The results are compared with a desired answer to quantify an error of the inference. That quantified error is then used to adjust an internal set of weights within the artificial neural networks to improve the performance of the artificial neural network. This technique of inference attempt, error quantification, and adjustment of internal weights is known supervised learning.

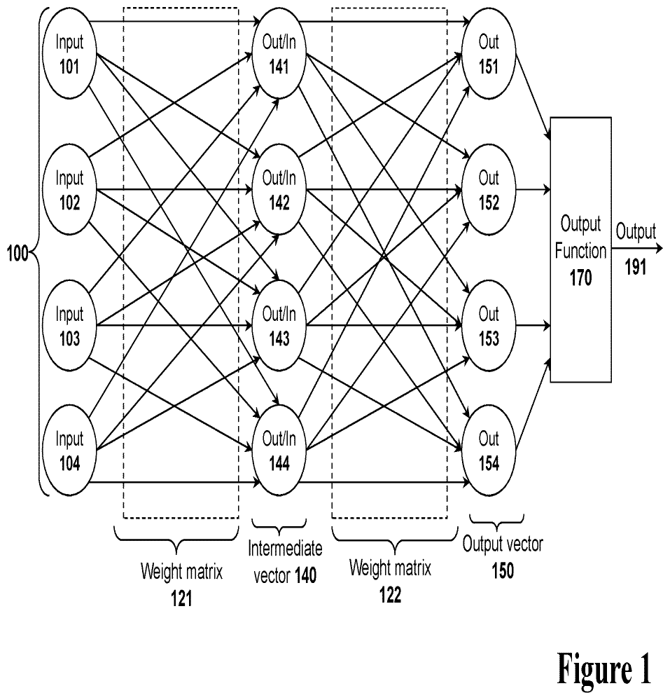

FIG. 1 illustrates a conceptual diagram of a simple two-layer four-input artificial neural network (ANN) 100. Referring to the artificial neural network (ANN) of FIG. 1, input data values 101 to 104 form an input data vector 100 that is provided with training data vectors during training sessions. (Note that this is just a very simplified example neural network, a neural network may have an input data vector with hundreds or thousands of input data values.) After completing training, the input data vector 100 will be provided with new input data vectors such that the artificial neural network can perform inferences on the new input data vectors.

The input data vector 100 is processed with set of neural network layers that combine the input data values with weight matrices to create an output data vector 150. In the two-layer neural network example of FIG. 1, the first neural network layer processes the input vector 100 with a first weight matrix 121 to create an intermediate data vector 140 (data values 141 to 144) and a second neural network layer processes the intermediate vector 140 with second weight matrix 122 to create an output data vector 150 (data values 151 to 154). Again, a neural network will generally comprise many more data values and neural network layers than this simple example. Many different types of data processing may be performed using weighted matrices 121 and 122 (such as a Hadamard product, Frobenius inner product, matrix addition, etc.) however this document will focus upon the well-known linear algebra matrix product. (Note that the techniques described in this document can be used with any of these other data processing operations.)

After processing the input data vector 100 (data values 101 to 104) with the artificial neural network layers to create the output data vector 150 (output data values 151 to 154), the output data vector 150 may be combined with an output function 170 to create a final output 191 for the artificial neural network. The output function 170 may be referred to as an activation function.

Artificial neural networks may comprise many layers of weight matrices such that very complex analysis of the input data may be performed. The output data from an artificial neural network may also be used as intermediate data that is fed into additional artificial neural network layers (not shown) such that very complex hierarchical artificial neural networks may be created.

Analyzing Digital Images with Neural Networks

As illustrated in FIG. 1, an artificial neural network accepts a one dimensional input vector 100 for neural network processing. In contrast, a digital image consists of a large two-dimensional array of pixel data values. For example, a black & white digital image may consist of a single two-dimensional array of pixel grayscale values. Similarly, a color digital image may consist of three separate two-dimensional arrays of red, green, and blue pixel color values. Therefore, before analyzing a digital image with an artificial neural network, a digital image must first be converted into some type of one-dimensional vector form for processing with a typical artificial neural network.

Avery simple method of converting a two-dimensional digital image into a one-dimensional vector is to simply “flatten” the digital image by converting all of the rows of two-dimensional array into one very long one-dimensional data vector made up of concatenated rows of pixel data from the original two-dimensional image. This technique has been used in some neural network systems for image analysis but the results from such systems are generally poor. This simple technique of flattening the data removes some important embedded information such as the adjacency of pixels in the same column. Furthermore, the flattened image data will be an extremely long one-dimensional vector. For example, a 1920 by 1080 high-resolution image made up of red, green, and blue pixel color components would create a long one dimensional array with 1920*1080*3=6,220,800 data values in it. Such a long one-dimensional vector is impractical. Thus, other systems have been developed for converting source digital images into a one dimensional data vector for processing by an artificial neural network.

One of the best systems of converting two-dimensional digital images into a one-dimensional vector for neural network processing is the use of a convolutional neural network (CNN). With a convolutional neural network, each source digital image is processed with a series of feature extraction steps that attempt to extract important feature information from the source digital image and reduce the size of the data. The output of the feature extraction steps is generally a dense three-dimensional data array.

That array may be processed with pooling step and then flattened into a one-dimensional data vector. However, due to the feature extraction processing steps, the one-dimensional data vector provides much better results than a two-dimensional digital image simply flattened into a one-dimensional data vector.

### Convolutional Neural Networks Overview

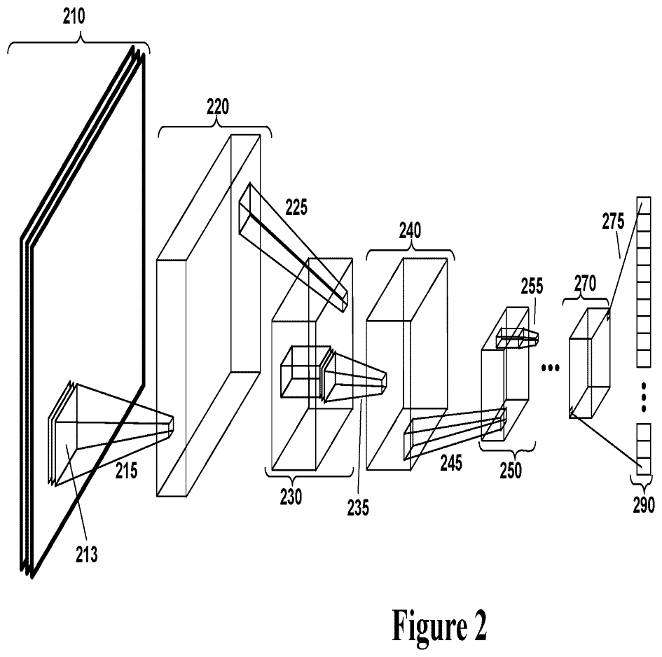

FIG. 2 illustrates a conceptual diagram of the feature extraction processing steps for an example convolutional neural network. On the very left-hand side of FIG. 2, three two-dimensional arrays 210 of red, green, and blue pixel data values represent a color digital image that is to be processed. The digital image data is then processed by a series of processing steps to extract image features and reduce the amount of data. The output of the feature extraction processing steps is the one-dimensional data vector 290 on the right-hand side of FIG. 2. The one-dimensional vector 290 can then be processed by an artificial neural network (ANN) like the ANN illustrated in FIG. 1 to perform classification.

In the example of FIG. 2, the source two-dimensional digital image arrays 210 are first convolutional processed 215 with a series of convolutional filters 213. The convolutional filters 213 help extract features out of the source digital image arrays 210. There are a wide variety of convolutional filters for tasks such as edge detection, blurring, sharpening, etc. Several different convolutional filters may be applied to extract different features from the source digital image arrays 210. The output of the convolutional processing with several convolutional filters 213 is a three-dimensional data array 220.

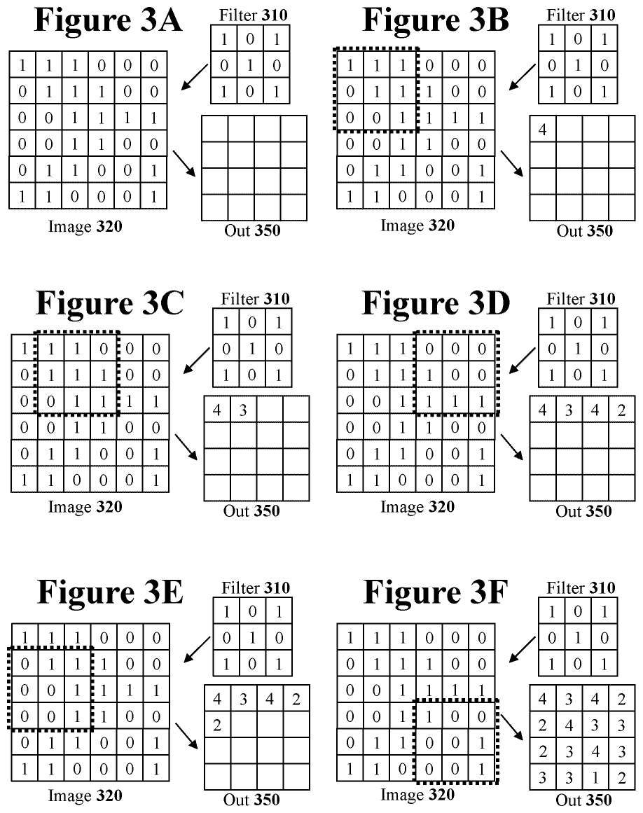

A simple example of applying a convolutional filter to a digital image array is presented with reference to FIGS. 3A to 3F. Referring to FIG. 3A, a small six pixel by six pixel digital image 320 is to be processed with a three by three convolutional filter 310 with the output to be placed into a new output array 350. To process the image, the convolutional filter 310 is applied to sections of the digital image 320, the corresponding data values are multiplied, and the sum of the multiplication operations is place into the output array 350. For example, FIG. 3B illustrates the convolutional filter 310 applied to the upper-left corner of digital image 320, the corresponding data values are multiplied, and the sum of the multiplications is then placed into a corresponding location (the upper right corner) of the output array 350. In this example, the upper-left, upper-right, center, and lower-right positions of the convolutional filter 310 create multiplication outputs of “I” that are then all summed together to place an output value of “4” in the output array 350.

Note that each convolutional operation may also include a rectifier operation. Specifically, a rectified linear unit (ReLu) may apply a function to the output of each convolution operation. A typical ReLu function is the f(x)=max(0,x) but many different ReLu functions may be used. Thus, each convolutional operation mentioned in this document may be comprised of both a convolution operation and a ReLu operation.

The convolutional filter is then applied to the remainder of the digital image 320. In this example, the convolution operation uses a “stride” of one such that the convolutional filter 310 is moved over one pixel as illustrated in FIG. 3C to create a convolution output of “3” in the next position of the output array 350. (If a stride of three was used, the next position of convolutional filter 310 would have been three pixels over as illustrated in FIG. 3D.) The convolutional filter 310 continues to stride across the digital image 320 generating convolution output values that are placed into the output array 350 until the entire first row of the output array 350 is filled as illustrated in FIG. 3D.

After completing the first row as illustrated in FIG. 3D, the convolutional filter 310 strides down one pixel row and is applied to the left-most portion of the second, third, and forth rows as illustrated in FIG. 3E. The output from that convolutional operation (“2”) is placed in the left-most entry of the second row of the output array 350. The convolutional filter 310 continues to stride across and down the digital image 320 until convolutional filter 310 reaches the very bottom-right corner of the digital image 320 and thus completes the output array 350.

Note that this is just a very simple example of a convolution operation and that there are many different variations. A padding of zeros may be placed around the perimeter of the digital image 320 such that the output array 350 is the same size as the digital image 320. The convolutional filter maybe larger or smaller, a different shape, and contain different constant values within it. Furthermore, many other types of digital image processing and feature extraction techniques may be used to create different output data values in the output array 350.

Returning back to FIG. 2, the output of the convolutional operations 215 are collected in the three-dimensional intermediate array 220. Several different convolutional filters may be applied thus creating several output arrays such that three-dimensional output array 220 becomes thick with multiple stacks of output arrays. To reduce the amount of data, pooling operations may be applied. FIG. 2 illustrates a first pooling operation 225 that reduces three-dimensional intermediate array 220 into a smaller three-dimensional intermediate array 230.

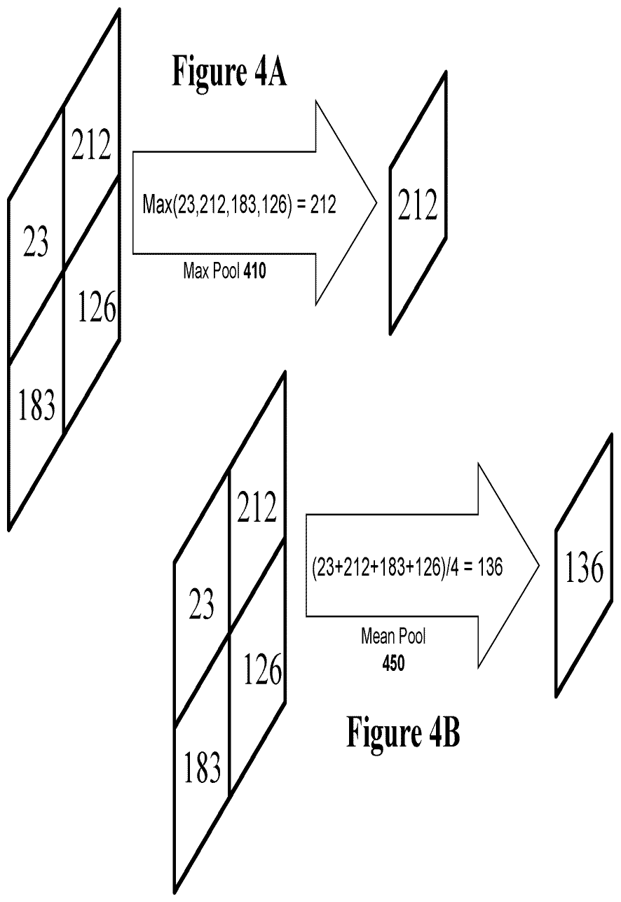

Pooling operations generally reduce the data by averaging together sections of data or selecting one particular data element from a collection. FIGS. 4A and 4B illustrated two possible four to one pooling operations that receive four data values as inputs and output one data value as output. FIG. 4A illustrates a Max Pooling 410 operation wherein the maximum data value from a set of four data values is output. FIG. 4B illustrates a Mean Pooling 450 operation wherein the mean of four data values is calculated and output as a data value.

Referring back to FIG. 2, three-dimensional intermediate array 230 may be processed with an additional convolution operation step 235 to create another three-dimensional intermediate data array 240. The convolution operation step 235 may extract higher level features from within the data of three-dimensional intermediate array 230.

Next, another pooling operation 245 may be used to further reduce the data. As illustrated in FIG. 2, pooling operation 245 reduces three-dimensional intermediate array 240 into smaller three-dimensional intermediate data array 250. A series of additional convolution, pooling, and/or other operations may be performed on the data ultimately yielding a final three-dimensional data array 270.

The final three-dimensional data array 270 contains a concentrated feature rich data set. To prepare the feature rich data set of the final three-dimensional data array 270 for classification analysis by an artificial neural network, the data within final three-dimensional data array 270 is flattened into a one-dimensional data vector 290. The one-dimensional data vector 290 can then be analyzed with an artificial neural network (ANN) such as a larger one of the ANN illustrated in FIG. 1.

Memory Consumption with Convolutional Neural Networks

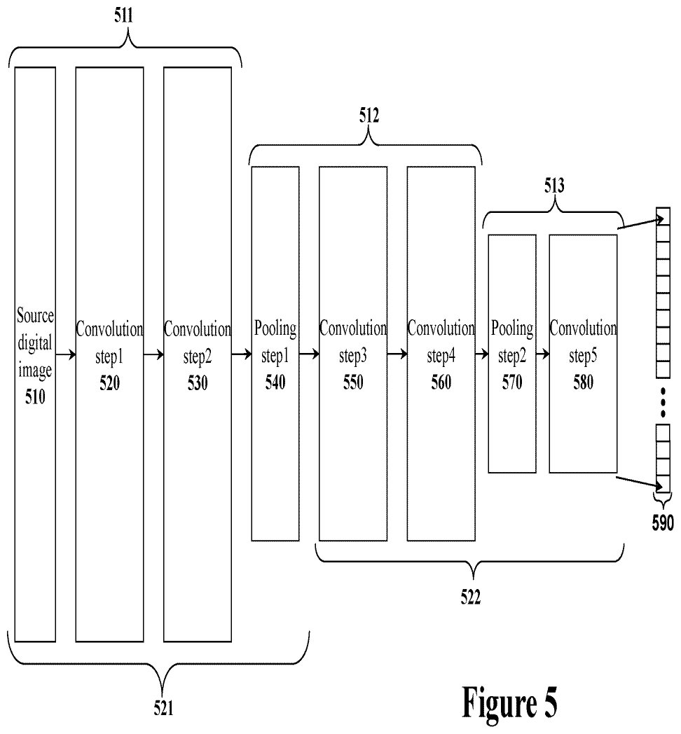

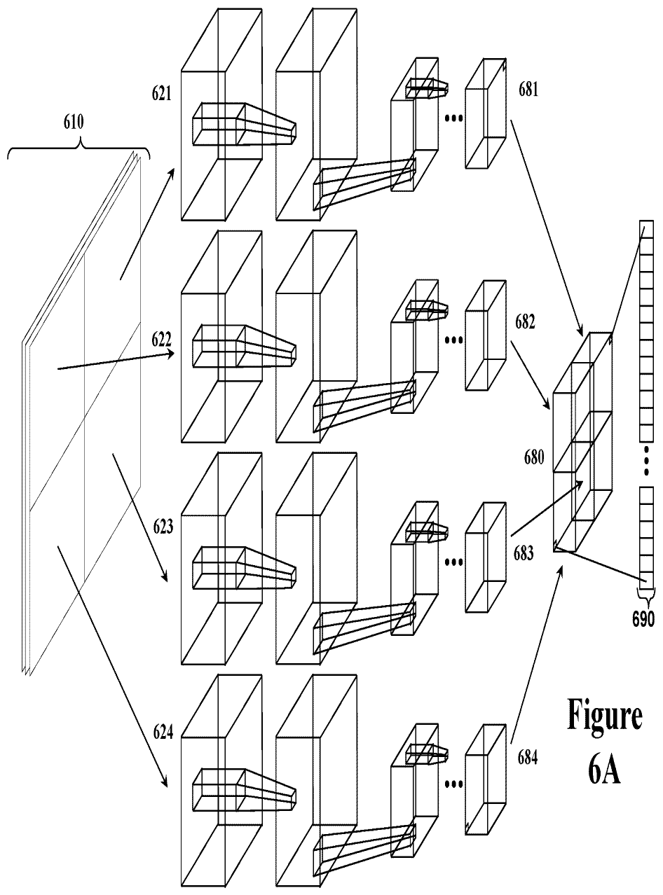

As illustrated in the example convolutional neural network (CNN) illustrated in FIG. 2, a convolutional neural network uses a long series of feature extraction processing steps to extract features from digital images. FIG. 5 illustrates a block diagram of an example set of feature extraction steps for another example of a convolutional neural network. The example convolutional neural network of FIG. 5 starts with a source digital image 510 that is first processed through two convolutional processing steps (520 and 530). Next, a first pooling step 540 reduces the amount of data. The reduced data is then processed by two more convolutional processing steps (550 and 560). Another pooling step 570 further reduces the amount of data. Finally, one more convolutional processing step 580 before the feature rich data is flatted into a one-dimensional vector 590 for classification processing by an artificial neural network.

In typical system, all of these feature extraction steps are each fully completed, step by step, in this order. Specifically, first the source digital image 510 is processed by convolutional step1 520 to create a first full intermediate data array. That intermediate data is then fully processed by convolutional step2 530 to create another intermediate data array. That intermediate data array is then reduced by pooling step1 540 to create a smaller intermediate data array. Next, that smaller intermediate array is fully processed by convolutional step3 550 to create another intermediate data array. The CNN system proceeds along in this manner, fully processing the data during each processing step and creating new data arrays until a final data array is created after convolutional step5 580. The final data array is then flattened into a one-dimensional vector 590 for classification processing by an artificial neural network.

This method of processing the digital image data to extract feature information is very memory intensive. Large amounts of digital data must be continually moved from memory, into computational units, and then back to memory. Thus, this feature extraction processing requires large amounts of memory space and memory bandwidth. A significant amount of time performing this type of digital image processing and feature extraction is just spent loading data from memory for processing and then storing processed data back into memory. Thus, just moving data back and forth between memory and computational units becomes a significant performance bottleneck that can severely limit computational performance and energy efficiency of the convolutional neural network.

### Caching Data to Improve Performance

The traditional technique of improving performance in a computer system that has become performance limited due to a large amount of memory operations is to add some type of local cache memory to the computer system. The local cache memory is added proximate to the computational circuits such that data is frequently accessed from the local cache memory and the number of accesses to a main memory can be reduced. For example, microprocessors frequently add multiple levels of high-speed cache memory that are closely coupled to the microprocessor and/or within the microprocessor. In this manner, frequently accessed instructions and data can be quickly read from the high-speed cache memory and stored back to that high-speed cache memory without incurring the time and energy penalty of accessing the main memory system of computer system.

This same technique can be used for processing systems designed to handle convolutional neural networks. Specifically, a limited amount of local cache memory can be implemented proximate to the computational circuits that perform mathematical and logical operations on the data associated with the convolutional neural network. In this manner, the performance of such convolutional neural network systems may be improved. Note that this document will discuss a “local cache memory” or a “local memory”; this local cache memory may be implemented in many different forms. It may comprise local static random access memory (SRAM) added to a processor system, it may comprise a multi-tiered cache memory system, or it may comprise any other type of local memory system added to improve performance over a larger main memory system.

Although simply adding some local cache memory system without any other changes may help to some degree, it may be difficult to significantly improve the performance of the feature extraction processing phase associated with convolutional neural networks. As illustrated in FIGS. 2 and 5, convolutional neural networks may operate on very large data sets starting with high-resolution digital images that are then processed with multiple convolutional filters through multiple convolutional processing steps creating several intermediate data arrays (220, 230, 240, 250, etc.) before generating a final output vector 290. Working serially through such large data sets will generally still require large number of accesses to external memory storage and thus the improvement gained by adding small local cache memory to the system may be very limited.

Partitioning Images into Sections for Convolutional Neural Networks

As set forth in the previous section, the very large data sets involved in convolutional neural networks can greatly limit the performance gains that may be achieved by adding a local cache memory system since the main memory system will still be required to store the very large data arrays involved in a convolutional neural network. Thus, one technique that may be used to improve performance in conjunction with a local cache memory system is to reduce the size of the data set being operated on.

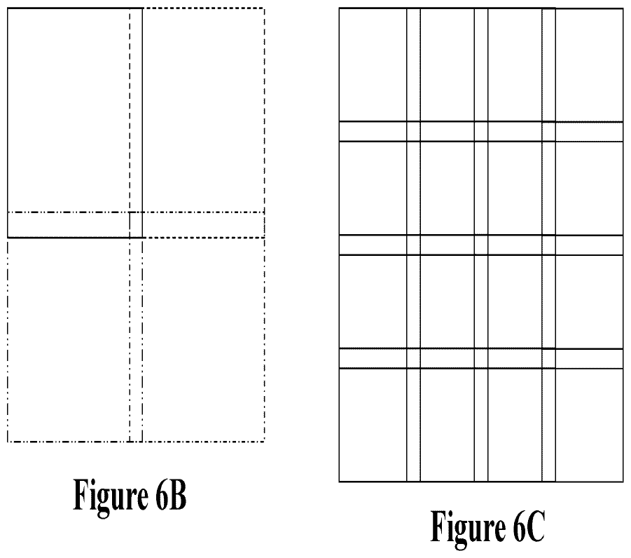

FIG. 6A illustrates a conceptual diagram of the feature extraction steps of the convolutional neural network of FIG. 2 wherein the original digital image source data 610 has been divided into four quadrants. The four quadrants 621, 622, 623, and 624 may then each be individually processed with the feature extraction steps of the convolutional neural network until a final data array is created for each quadrant. Specifically, source digital image quadrants 621, 622, 623, and 624 may be processed into final data array quadrants 681, 682, 683, and 684 respectively. The final data array quadrants 681, 682, 683, and 684 can be then combined together into a full final data array 680. Full final data array 680 may then be flattened into one-dimensional vector 690 for classification processing by a traditional artificial neural network like the one illustrated in FIG. 1.

Dividing up the digital image data for the feature extraction processing steps of a convolutional neural network is not as clean as illustrated in FIG. 6A. For example, the boundaries between the different quadrants are not sharp lines. Instead, the quadrants must overlap each other as illustrated in FIG. 6B in order to generate the proper results. This means that some calculations on the borders between the different quadrants will be duplicated thus increasing the number of computations performed. However, the time savings from the use of local cache memory may more than compensate for these additional calculations.

Another issue is that although the simple example of FIGS. 6A and 6B illustrate the digital image source data divided into four quadrants, a real implementation may require dividing the source digital image data into many smaller areas in order to have all the data digital image data and later intermediate data arrays fit within the smaller local cache memories. For example, FIG. 6C illustrates a digital image source data that has been divided into sixteen overlapping sub-areas such that every sub-area can fit within a local cache memory system. However, as is apparent from FIG. 6C, this greatly increases the amount of overlapping area such that many more redundant calculations may need to be performed.

### Cone of Dependency and Cone of Influence

One of the keys to convolutional neural network feature extraction is to extract image feature information formed by patterns in nearby pixels. For example, nearby pixels may form image features such as edges, an eye, a letter, a shape, a number, a face, etc. This is why the convolutional filters that are applied that combine nearby pixel information to extract feature information. Combining pixels distant from each other in an image does not yield much useful feature information.

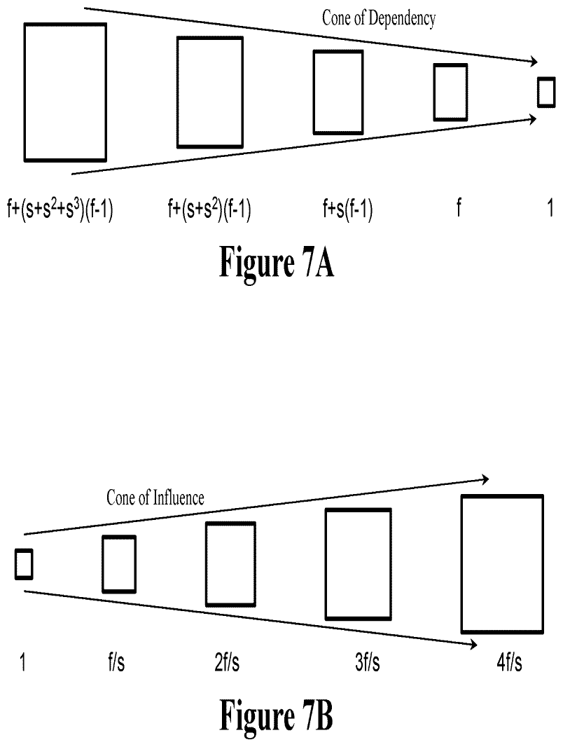

Since only nearby pixel information is combined together with a series of convolutional operations, this creates a “cone of dependency” from nearby data in all the earlier processing steps. For example, in a convolutional neural network that uses an f by f convolutional filter, every data value depends only on f by f data values from the prior step. As the number of convolutional processing steps grows, this grows into a cone of dependence on larger numbers of data values from every earlier convolutional step. FIG. 7A illustrates the cone of dependence of a single data value on the right being dependent on more and more data values from every earlier convolutional step for a convolutional neural network with an f by f filter with a stride of s.

This phenomenon can also be viewed in the other direction. Specifically, a single data pixel from a digital image influences the output of a larger and larger number of intermediate data values in successive convolutional steps. FIG. 7B illustrates this “cone of influence” starting from a single data pixel on the left influencing more and more intermediate data values in every successive convolutional step for a convolutional neural network with an f by f filter with a stride of s.

As illustrated in FIG. 7B, each pixel from a digital image affects a larger number of intermediate data values in every successive convolutional step. However, the amount of influence is ultimately limited such that each pixel only affects a small number of nearby data values in later steps and does not affect the many more intermediate data values distant from a source pixel. And as illustrated in FIG. 7A, a final data value on the right side is only dependent on a small subset of pixels from the source digital image.

As illustrated with FIGS. 7A and 7B, one does not need to have all of digital image pixel data available to calculate a final data output value after a series of convolutional steps. Instead, as illustrated in FIG. 7A, only the limited number source pixels that a final data value depends on need to be available. This can be used to improve convolutional neural network calculation efficiency by keeping only a small amount of pixel data in a local cache memory in order to quickly calculate through several convolutional layers to generate intermediate or even final convolutional neural network data output values. Thus, this technique can greatly reduce the amount of reads from and writes to a main memory system and therefore greatly improve convolutional neural network performance.

To most clearly illustrate these improved feature extraction processing techniques, this document will switch from two-dimensional data examples to one-dimensional examples. The one-dimensional based examples simplify the drawings to more clearly illustrate the techniques but the very same principles can be applied to normal feature extraction processing from two-dimensional digital images. As illustrated in FIG. 2, even just a high level conceptual diagram of the convolutional neural network feature extraction processing steps is complex without data representations. Figures SA to SD conceptually illustrate a small convolutional neural network with three feature extraction steps that operates in a traditional manner on a one-dimensional source data vector 810. Each convolutional step uses a one-dimensional convolutional filter (813, 823, and 833) that is 3 data units wide and creates a single output data value. Furthermore, in this one-dimensional convolutional neural network example the 3-data-wide convolutional filters will be moved with a stride of one (“1”).

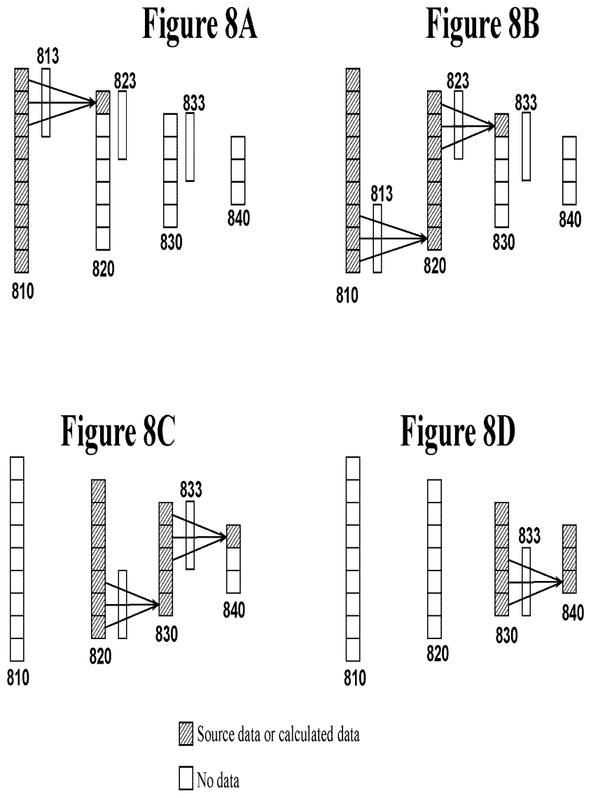

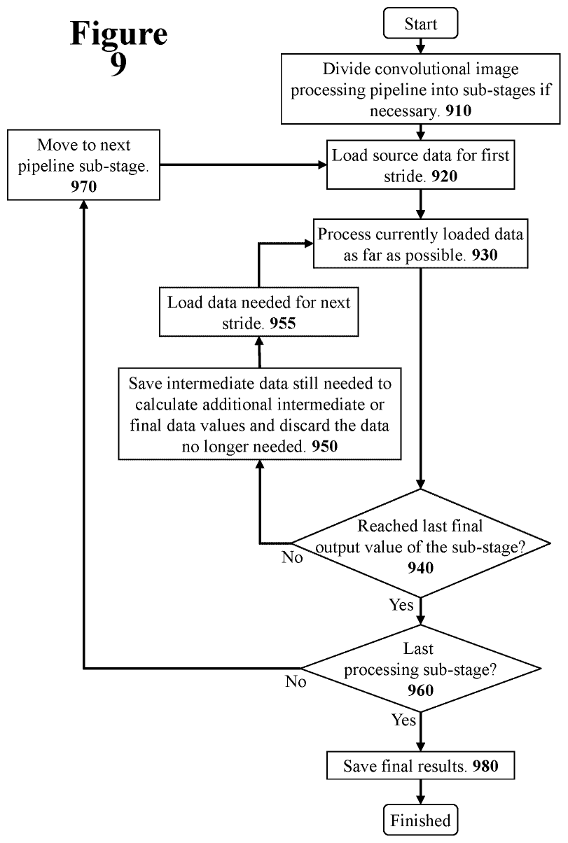

Referring to FIG. 8A, the traditional convolution processing operation begins by performing a first convolution operation on the first three data values in source data array 810 with convolutional filter 813 to create a first intermediate data value in intermediate array 820. The convolutional filter 813 then moves down one pixel at a time (stride of 1) calculating successive intermediate data values. After striding the convolutional filter 813 down the entire source data array 810 the intermediate array 820 will be filled with data values as illustrated in FIG. 8B.

After completing the first convolution layer, the second convolution layer can then begin feature extraction processing the intermediate data values in intermediate array 820. FIB. 8B illustrates convolutional filter 823 being applied to the first three data elements in intermediate array 820 to create a first data value in the next intermediate array 830. The system then has convolutional filter 823 stride down intermediate array 820. FIG. 8C illustrates the situation after striding the convolutional filter 823 down through the entire intermediate array 820 creating all the data values in intermediate array 830.

At this point the final convolutional feature extraction step can begin operation with filter 833. FIG. 8C illustrates convolutional filter 833 being applied to the first three data elements in intermediate array 830 to create a first data value in the next intermediate array 840. Finally, FIG. 8D illustrates the completed operation after striding the final convolutional filter 833 down the entire intermediate array 830 to generate the final output data values in the final array 840.

Referring to the one-dimensional convolutional neural network feature extraction processing set forth in FIG. 8A to 8D, the system will either require very large amounts of data to be stored in local cache memory (often impossible) or require large amounts of data to be moved in and out of main memory storage. Thus, the convolutional neural network feature extraction processing set forth in FIG. 8A to 8D will be inefficient and slow. To improve on convolutional neural network feature extraction processing, this document discloses systems that take advantage of the cone of dependency and cone of influence phenomenon described with reference to FIGS. 7A and 7B.

### Cone of Dependency Based Processing

As described with FIGS. 7A and 7B each intermediate data value or final output data value of convolutional neural network image processing only depends on a limited set of nearby source pixels. Therefore, if one keeps those nearby pixels in local cache memory then one can quickly and efficiently calculate the final output data values of convolutional neural network feature extraction processing by reducing costly main memory accesses. Furthermore, by adding more nearby pixels as needed and dropping other pixels and data no longer needed, a cone of dependency based processing system can calculate final output data values very efficiently without large numbers of repeated accesses to a main memory system. These “cone of dependency” and “cone of influence” techniques may be combined with the technique of dividing images into subareas as described with reference to FIGS. 6A, 6B, and 6C to ensure that all of the data needed for feature extraction processing will remain in local cache memory such that the feature extraction processing can be performed quickly and efficiently.

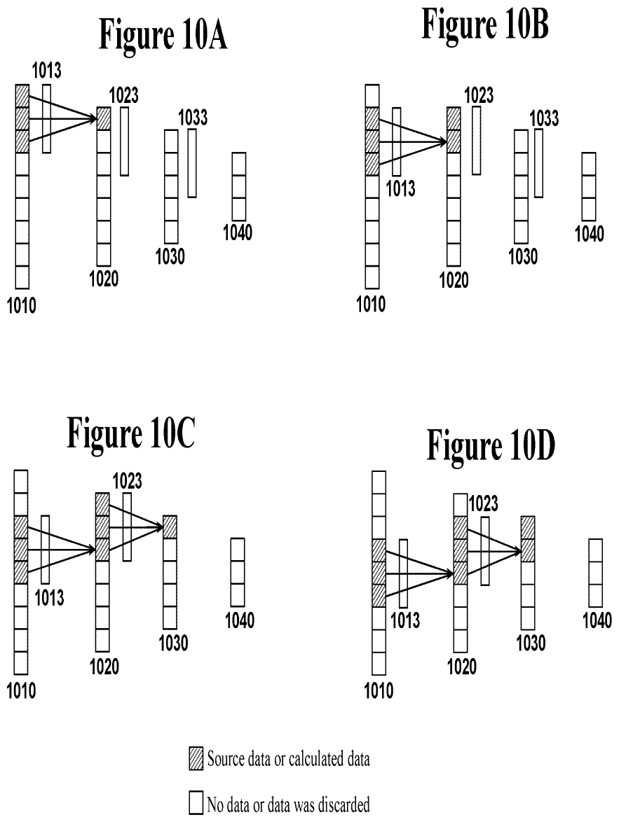

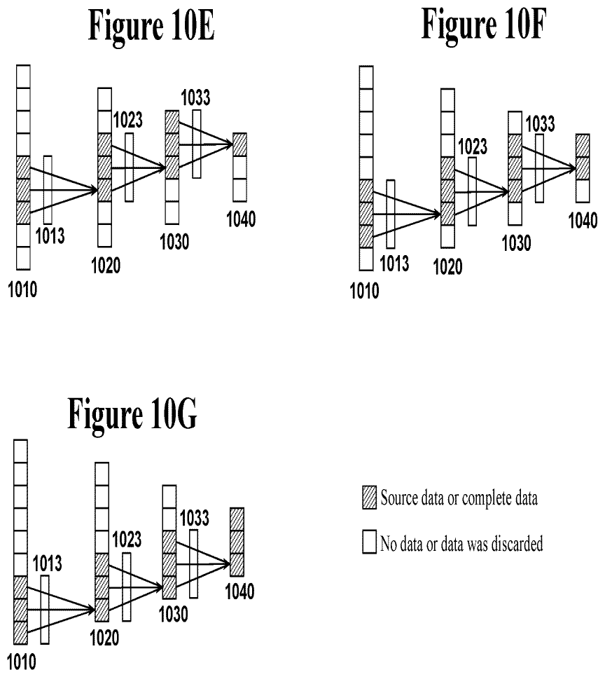

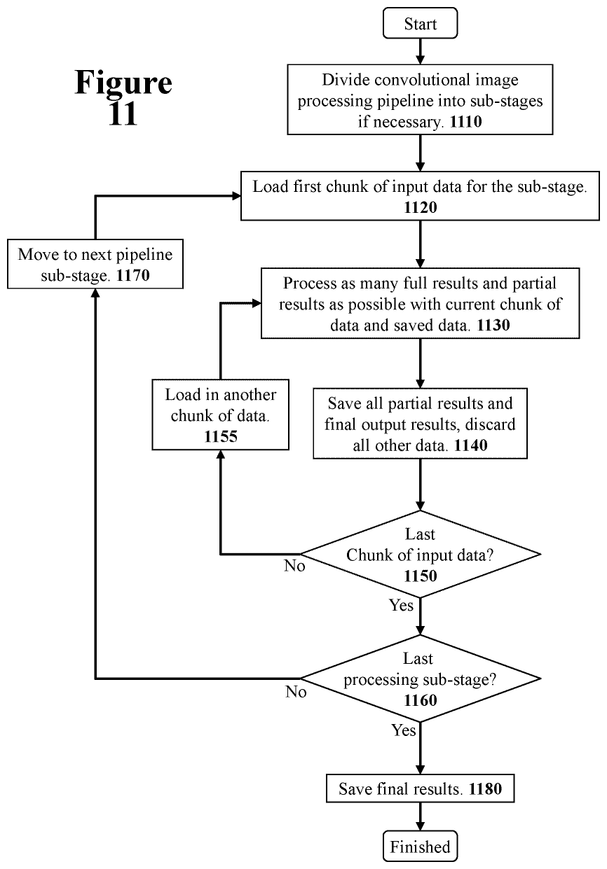

A cone of dependency based feature extraction processing technique will be described with reference to the flow diagram of FIG. 9 and the conceptual processing diagrams of FIGS. 10A to 10G. Referring to the flow diagram of FIG. 9, a first step that may be taken is to divide a convolutional neural network feature extraction processing pipeline into sub-stages if necessary. Referring back to the example convolutional neural network image processing pipeline of FIG. 5, it may be difficult to compute an entire long convolutional neural network (CNN) processing pipeline in a single processing pass. Thus, the CNN feature extraction processing pipeline may be broken into three sub-stages 511, 512, and 513 or the feature extraction processing pipeline may be broken into two sub-stages 521 and 522. Or the feature extraction processing pipeline might not be broken into sub-stages at all if the entire feature extraction pipeline can be performed within local cache memory.

Referring back to FIG. 9, the system then loads in the source data for the first convolutional stride at step 920. This is illustrated in conceptual processing diagram of FIG. 10A as the first three pixels of data loaded in digital image array 1010. Next, at step 930, the system processes the currently loaded data as far as possible along the feature extraction processing pipeline. As illustrated in FIG. 10A the CNN processing system can only perform that one single convolution operation with filter 1013 to create an intermediate data value in intermediate array 1020.

The system then proceeds to step 940 where it determines if the last final output value has been calculated for the sub-stage. That would require all three values of final output array 1040 to be filled with final calculated data and thus is clearly not the case yet. Thus, the system proceeds to step 950 where the system saves in the local cache memory all intermediate data still needed to calculate additional intermediate or final data values and also discards the data values no longer needed. In this case, the top-most pixel in digital image array 1010 is no longer needed to calculate any additional intermediate or final data values and thus is discarded as illustrated in FIG. 10B.

The system then loads additional pixel data needed for the next stride at step 955. This means that the fourth from the top pixel in digital image array 1010 is loaded with valid data. The system then returns to step 930 where it again attempts to process the currently loaded data as far as possible though the feature extraction pipeline. As illustrated in FIG. 10B, this again means that the system can only perform a single convolution operation with filter 1013 to create a second intermediate data value in intermediate array 1020.

The CNN processing system will then continue to proceed through the loop of steps 930, 940, 950, and 955 until processing for the current sub-stage is complete. In the next iteration of the loop, a third data value is calculated from pixel data in digital image array 1010 with filter 1013 to create a third intermediate data value in intermediate array 1020 as illustrated in FIG. 10C. Now with three calculated intermediate data values in in intermediate array 1020, filter 1023 can operate on the three intermediate data values in intermediate array 1020 to calculate a first intermediate result in intermediate array 1030.

FIG. 10D illustrates the next iteration of the loop wherein both filters 1013 and 1023 are now striding down respective data arrays 1010 and 1020 during each iteration and generating intermediate data. Note that data that will no longer be needed is immediately discarded such that amount of data that is stored remains relatively small and can be kept within a local cache memory. The only data that needs to enter into the system is additional source pixels read into in pixel array 1010. That pixel data is added in only a pixel at time in this example such that there is very little strain on memory bandwidth. The only accesses to the main memory system are a pixel by pixel reading of the source image data. (Note that this is just one embodiment, the pixels could also be read in groups at a time to improve efficiency.)

FIG. 10E illustrates the next iteration of the loop wherein all three convolution filters 1013, 1023, and 1033 are now striding down during each loop iteration generating intermediate data. Again, note that any data values no longer needed for further calculations are immediately discarded such that amount of data kept in the local cache memory is minimized. In FIG. 10E, the CNN processing system has now generated one of the final output data values in final data array 1040. But since it is not the last final output data value, the CNN system continues processing. FIG. 10F illustrates the next iteration wherein all three convolution filters 1013, 1023, and 1033 output another data value into data arrays 1020, 1030, and 1040, respectively. Note that each of the data arrays 1020, 1030, and 1040 now only have to store the data values necessary to supply the associated convolutional filters (1013, 1023, and 1033, respectively) with data. All other data can be discarded.

Finally, FIG. 10G illustrates a final iteration wherein all three convolutional filters 1013, 1023, and 1033 output one more data value. Referring back to FIG. 9, since the last final output data value has been put into data array 1040 the processing for this sub-stage is complete at step 940. Next, at step 960, the system then determines if this is the final processing sub-stage. If not, the system proceeds to step 970 where it moves to the next pipeline sub-stage and then processing begins for that next sub-stage at step 920. If it was the final processing sub-stage at step 960 then the system is complete and the final feature extraction results can be saved at step 980.

As illustrated in the conceptual processing diagrams of FIGS. 10A to 10G, the CNN processing system may load in source pixel data only as necessary and may discard any data when that data is no longer necessary such that the amount of data is minimized and can be kept within a limited local cache memory system. Furthermore, although this example has been described with reference to convolutional steps in the pipeline, these steps could just as easily have been pooling or any other type of processing.

### Cone of Influence Based Processing

The previous section described a cone of dependency system for feature extraction processing wherein only the intermediate data that final output values are dependent upon are kept in the local cache memory. In a cone of influence mode of operation, each data value is calculated out as far as that data value influences later data values and then discarded. Since these convolutional operations combine results together with addition, partial results may be calculated and stored thus allowing calculations to proceed further such that intermediate data can be discarded faster.

The cone of influence feature extraction processing system is described with reference to the flow diagram of FIG. 11 and the conceptual CNN processing diagrams of 12A to 12C. As with the previous convolutional neural network example, this system operates with 3 data value wide convolutional filter that uses a stride of one.

Referring to step 1110 of FIG. 11, a long convolutional neural network feature extraction processing pipeline such as the one in FIG. 5 may first be divided into sub-stages comprising groups of processing steps to limit the operation. For example, the feature extraction processing pipeline may be divided into sub-stages 521 and 522 instead of attempting to process all of the feature extraction steps at once.

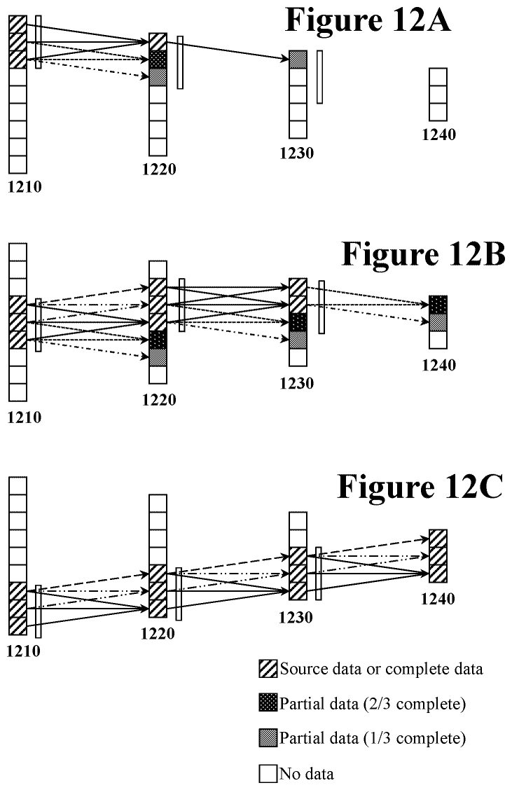

Referring back to the flow diagram of FIG. 11, the feature extraction processing begins at step 1120 wherein a first chunk of input data is loaded in for the current sub-stage. This is illustrated in the conceptual diagram of FIG. 12A as the first 3 data pixels loaded into pixel data array 1210. Next, the system then processes as many full results and partial results as possible with the currently available chunk of data (and saved data) as stated in step 1130. With the first chunk of data one full convolutional filter result can be calculated for the second data array 1220 as illustrated in FIG. 12A. Two partial results can also be calculated in the second data array 1220, one partial result from two source data values and one partial result from just one source data value. Furthermore, one partial result can be calculated in the third data array 1230 using the one complete intermediate data value at the top of second data array 1220.

Next, at step 1140 of FIG. 11, the system saves all the partial results and any final output results while discarding the current chunk of source data and any completed intermediate results. In the processing example of FIG. 12A, this means that only the two partial results in the second data array 1220 and the one partial result in the third data array 1230 are saved while all of the other data is discarded. The system can discard all the current source data and completed intermediate results because those data values have already been used as much as possible to calculate other partial results or final output results. In other words, those data values have been extended to their full influence.

Referring back to the flow diagram of FIG. 11, the system then proceeds to step 1150 where it determines if that was the last chunk of source data. If it was the last chunk of data, then all the final results should have been calculated and processing for the current sub-stage would be completed. But in the situation illustrated in FIG. 12A, only a first chunk of source data has been processed so the system proceeds to step 1155 where the CNN system loads another chunk of source data for feature extraction processing and then returns to step 1130 for additional feature extraction processing.

Returning to step 1130, the CNN system processes the newly loaded chunk of data and the saved partial results to their full influence to generate as many full results and partial results as possible from that data. Thus, the system begins feature extraction processing upon the three saved partial results saved from FIG. 12A and a new chunk of three source pixel data values loaded into pixel data array 1210 as illustrated in FIG. 12B. Specifically, the system calculates three full results and two partial results in second data array 1220, two full results and two partial results in third data array 1230, and two partial results in fourth (final) data array 1240 as illustrated in FIG. 12B.

After the processing of step 1130, the system then again proceeds to step 1140 where the system discards all of the data except partial result data and any final output results. Next, at step 1150, the system determines that it is not the last chunk of data such that the system proceeds back to step 1155 where the system then loads another chunk of source data for more feature extraction processing.

Finally, FIG. 12C illustrates the system as it performs a final processing through step 1130. As illustrated in FIG. 12C, the new chunk of source data in pixel data array 1210 completes three intermediate data results in second data array 1220. Those three complete intermediate data values in second data array 1220 are then used to complete three intermediate data values in the third data array 1230. And finally, those three completed intermediate data results in the third data array 1230 are used to complete the three final output data results in the fourth (final) data array 1240.

Referring back to FIG. 11, at step 1140, the system can then discard all but the final output results (the three final output data results in the final data array 1240). Next, at step 1150, the system determines that this was the last chunk of source data such that the feature extraction processing for this sub-stage is complete. The system then determines at step 1160 if this is the last processing sub-stage and if not, the system proceeds to step 1170 to move on to the next sub-stage of processing and begins feature extraction processing for that sub-stage at step 1120. (Note that the system may use the saved final results in the final data array 1240 as source data for later substages.) Otherwise, if this was the final sub-stage at step 1160 then the CNN processing system can save the final results of the convolutional neural network feature extraction processing at step 1180.

### Combining Techniques

The Cone of Dependency techniques in steps 930 to 955 and the Cone of Influence techniques in steps 1130 to 1155 can significantly reduce main memory accesses by computing several steps of CNN processing using small amounts of source data loaded into the system. By limiting the amount of source data loaded in and only continuing to store intermediate results that will be needed to calculate more results, the CNN processing system may be able to keep all of the needed data within a local cache memory system. The only accesses to main memory system are to load in source data in small amounts just once. In this manner, these CNN processing techniques can be used to quickly and efficiently generate the needed results with minimal access to a main memory system.

However, in many situations the Cone of Dependency techniques in steps 930 to 955 and the Cone of Influence techniques in steps 1130 to 1155 alone may not be enough to ensure that all of the data will fit within a local cache memory system. In order to most efficiently use the local cache memory, the parameters of the other two techniques for reducing memory usage disclosed can be adjusted. Firstly, the technique of partitioning source digital images into smaller subareas as set forth with reference to FIGS. 6A to 6C may be used to reduce the size of the source digital image data being processed. Secondly, the technique of dividing the long feature extraction processing pipeline into smaller sets of sub-stages as set forth with reference to FIG. 5 can be used to reduce the number of feature extraction processing steps that will be performed at once.

In this manner, by partitioning the source image data into smaller sections and dividing the feature extraction processing pipeline into smaller sets of sub-stages, a CNN processing system can find a setting wherein all of the data can fit within a local cache memory and thus optimize system performance. By optimizing cache memory usage (and thereby minimizing main memory accesses), the feature extraction processing system saves both processing time and energy thereby greatly performing the processing of convolutional neural network feature extraction processing.

### Slicing Images for Parallel Processing

The previous sections disclose techniques for optimizing the usage of 1 cache memory systems to improve the processing performance of feature extraction techniques used in convolutional neural networks. However, to further improve the performance, the feature extraction task of a convolutional neural network can be divided up into multiple different independent tasks and performed by multiple different processors in parallel.

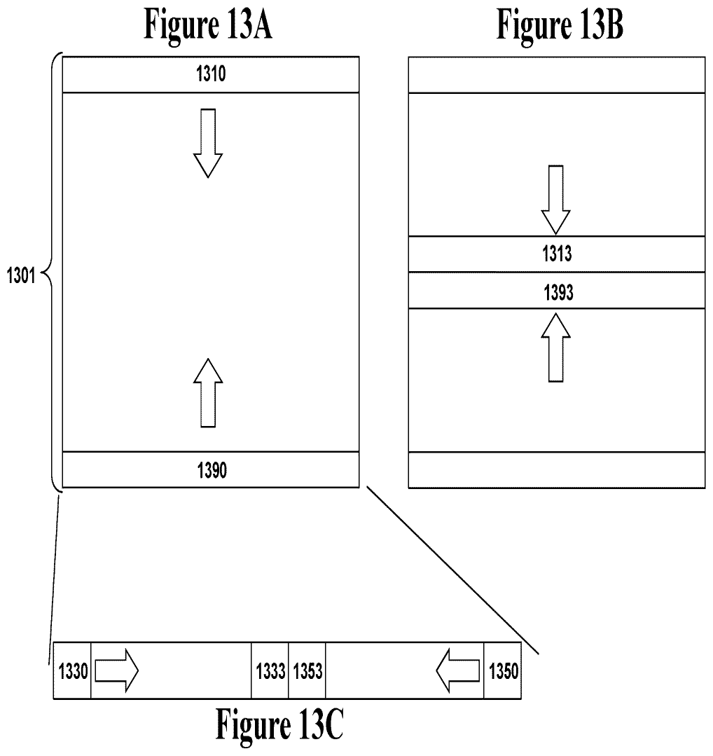

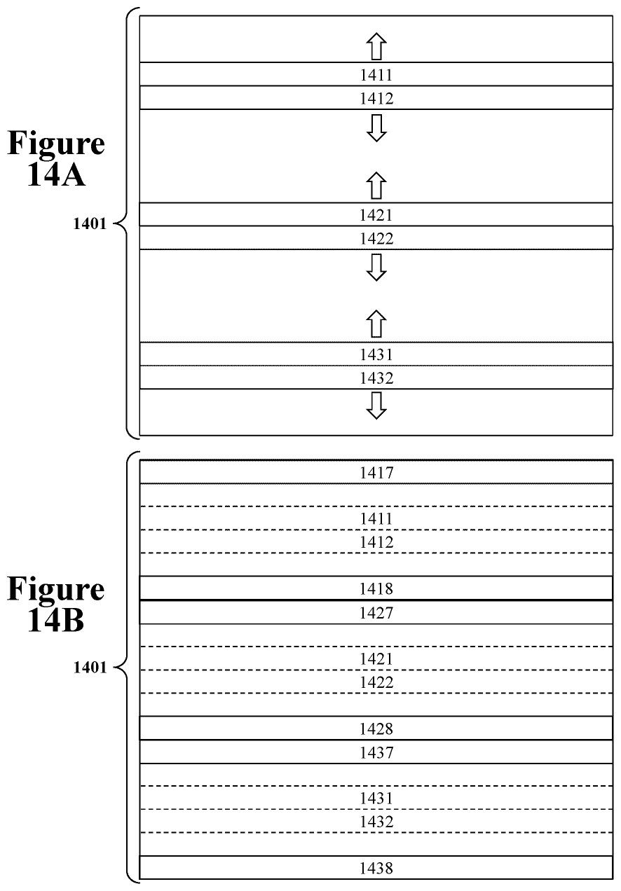

FIG. 13A conceptually illustrates a digital image 1301. To perform parallel convolutional processing of the digital image 1301, a first processing task can begin convolutional processing at the top slice 1310 proceeding downward and a second processing task can begin convolutional processing at the bottom slice 1390 proceeding upward. These two processing tasks will soon meet at the center as illustrated in FIG. 13B wherein two slices 1313 and 1393 meet. At this point, the two tasks must synchronize and the overlapping portion should be processed.

In addition to processing tasks that operate vertically, different processing tasks can execute horizontally in parallel. Below the digital image 1301 an expanded slice is illustrated in FIG. 13C. The job of processing the slice of FIG. 13C can be performed by two processing tasks (1330 and 1350) operating in parallel. Specifically, processing task 1330 starts on the left side of the slice and works its way rightward and while processing task 1350 simultaneously starts on the right side of the slice and works its way leftward. Again, the two processing tasks will soon meet as illustrated by processing tasks (1333 and 1353) and the overlapping area must be processed by one of the tasks.

The convolutional processing tasks can be divided many different ways. FIG. 14A illustrates a digital image 1401 that is being processed by six different convolutional processing tasks. Convolutional processing tasks 1411, 1421, and 1431 all move downward whereas convolutional processing tasks 1412, 1422, and 1432 all move downward. Again, convolutional processing tasks that meet must synchronize and handle the overlapping area. For example, convolutional tasks 1412 and 1421 will meet as illustrated in FIG. 14B as 1418 and 1427 where those processing tasks must synchronize and process the overlapping area. Similarly, convolutional tasks 1422 and 1431 meet as illustrated in FIG. 14B as 1428 and 1437 where those two processing tasks must synchronize and process the overlapping area.

Note that the horizontal techniques disclosed with reference to FIG. 13C can also be used in the example of FIGS. 14A and 14B. In this manner, twelve simultaneous processing tasks can very quickly convolutional process the entire digital image very quickly.

### Tensor Slicing for Reduced Memory Utilization and Parallel Processing

In another aspect of the disclosure, processes, and systems are presented for memory-efficient processing of a tensor by a transform and utilization of processing resources on a multiple-processor system. Preferably, the processors are one or more NPUs (neural processing units), TPUs (transform processing units), and GPUs (graphics processing units). Further, the processing system refers to a system that includes one or more NPUs, TPUs, and GPUs. Each of these units can include one or more cores with multiple computational units with the associated busses, caches, and interconnects to memory and other NPUs, TPUs, and GPUs.

The tensor can be a two-dimensional image having one or more channels. The tensor transform can be a convolutional that requires one or more tensor operations, but other tensor operations are within the scope of the invention. Specifically, tensor operations, convolutions for example, that only have an effect over a local region are suitable for this method. Another way of describing this is that the tensor needs to be sliceable in one dimension. For the purposes of discussion, an image, tensor with a row and a column dimension (XY), and multiple channels are sliceable in the row or X dimension.

In one aspect of the invention, the tensor is processed by first generating tensor slice data. Preferably, the tensor slice data is in the row dimension or X dimension. These slices can be segmented into memory-efficient sizes. The tensor segments provide for better utilization by the NPUs, TPUs, or GPUs, where a system with multiple processing cores operates simultaneously on different rows or segments of a row.

For this method, the transform needs to have a limited scope over the tensor data, a local effect. The tensor slice needs to have sufficient rows for the transform to operate on. For the purpose of this application, the term tensor slice data refers to the data in one or more rows of a tensor slice or one or more rows of a tensor slice segment. For example, if the transform is a 3×3 convolution, the convolution of each row within a slice utilizes the row above and the row below. For the first row in a tensor, a row can be generated above the first row and padded with a value that is often zero. For the last row in a tensor, a row can be generated below the last row and padded with zeros. Accordingly, five rows are required to process three rows in the tensor with a 3×3 convolution. If the tensor slice is “n” tensor rows, for a 3×3 convolution, n+2 rows are required in total for a correct convolution computation to occur. Additionally, data padding may be required at the edges of a tensor slice or edge of a tensor slice segment.

Between slice segments, one or more extra columns are required for the tensor transform. For a 1×1 convolution, no extra columns are required. For a 3×3 convolution, one extra column is required. Other transforms may require more extra columns. The column data comes from the adjacent slice segment or is padded for the end of a tensor slice.

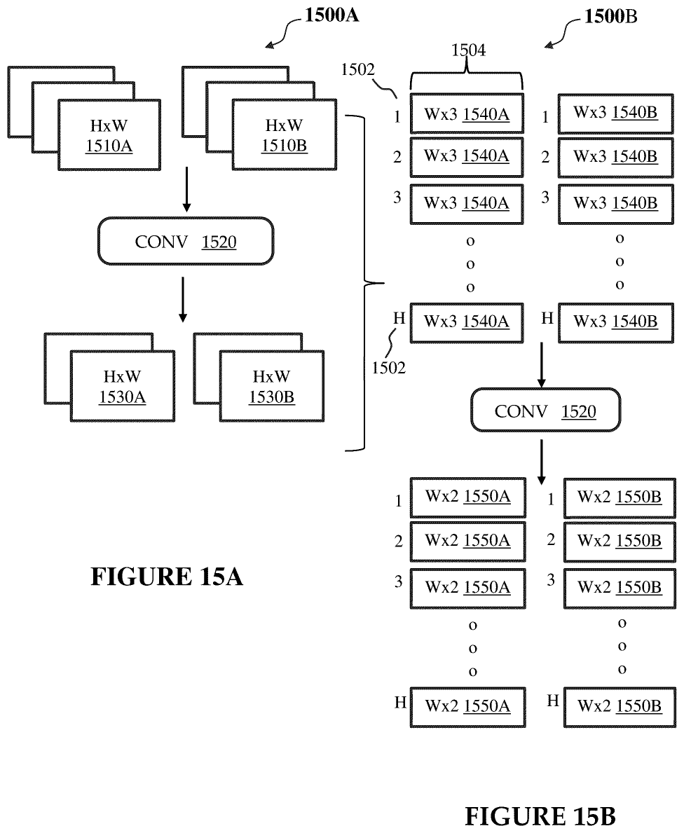

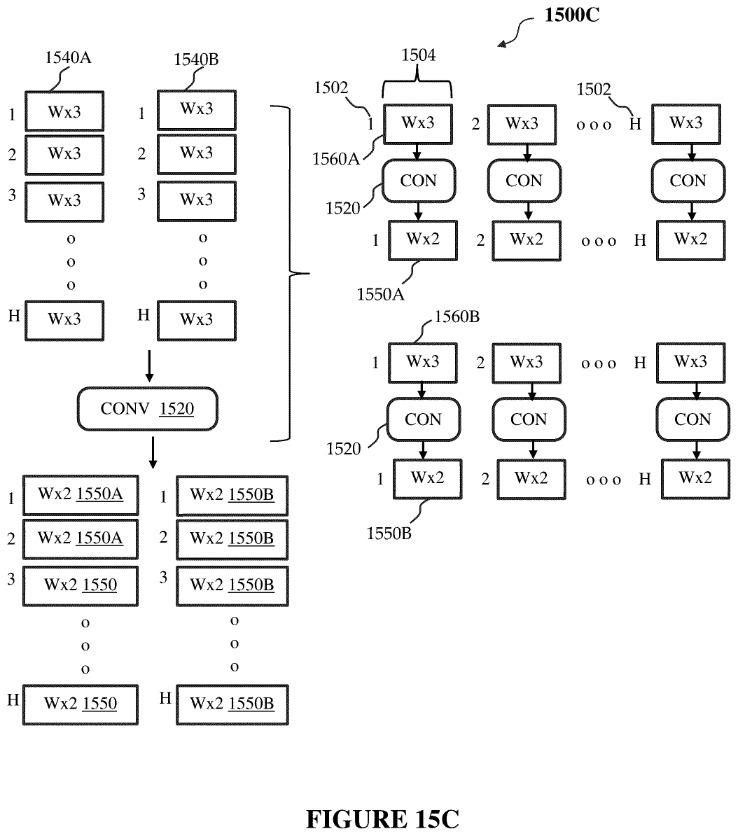

Referring to FIG. 15A and FIG. 15B, the figures illustrate the processing flow 1500A, 1500B of a tensor where the tensor transform is a convolution 1520. In this processing flow, the pair of three channel images 1510A, 1510B are processed by the convolution 1520 resulting in the processed tensors 1530A, 1530B.

The processing flow 1500B shows the convolution transform performed in slices. The convolution computation on the tensor starts by breaking the input tensor 1510A, 1510B into slices 1540A(1 . . . H), 1540B(1 . . . H) and performing the convolution computation 1520 on each slice. Other transforms than a convolution are contemplated including but not limited to multiple convolutions for classification, image rotation, translation, reflection, dilation, enlargement . . . . The resulting convolution slices 1550A (1-H) can be reassembled (not shown) to generate an identical result that would occur if the tensors 1510A, 1510B were transformed as one entire image, as shown in 1500A.

The two images 1510A, 1510B represent two batches of images to be processed. The images 1510A and 1510B are shown with the dimensions H×W (H rows 1502 and W columns 1504). The “W×3” represents the width “W” (also columns), and the “3” represents three channels that could be the color channels red, blue, and cyan image planes. The images 1510A and 1510B are processed by the 1×1 convolution filter 1520 generating the output 1550A and 1550B. The tensor slices 1540A (1 . . . H) and 1540B (1 . . . H) are single rows of data. The slices can be a single data row of the tensor because a 1×1 convolution computation only requires the immediate data in a single row and does not have a data dependency on other rows. In other embodiments, the tensor slices can be multiple rows.

In a more memory-efficient and processor utilization-efficient method 1500C, the input images 1510A and 1510B are divided into slices (1 . . . H) of dimension W×3 1540A (1 . . . H) and 1540B (1 . . . H). The slice can be one or more rows 1502 of width “W” 1504. For a 1×1 convolution, only a single row 1502 is required because the output of the convolution only depends on a single value within the image 1510A and 1510B. For example, if the width of the image “W” is 2048 pixels, the memory required for W3 would only be 2048*3 bytes. This requires much less memory than the whole image, which would be 2048*3*H bytes. Each slice is processed by the convolution 1520 to generate the convolutional computation slices (1 . . . H) 1550A and 1550B. These slices are also referred to as an output tensor slice. Note, that convolution 1520 can be performed on a row-by-row basis 1502 (1 . . . H), which enables each processor core to process the rows or a portion of the rows in parallel. Further, while each slice 1540A and 1540B and the resulting output tensor slices 1550A and 1550B resulting from the convolution 1520 use the same enumeration, the data slice and convolution data for each slice represent data from different parts of the image or convolution and can vary between slices. While not shown, (1 . . . H) W2 1550A and W×2 1550B can be recombined, generating a transformed H×W output identical to the result shown in FIG. 15A, H×W 1530A and 1530B.

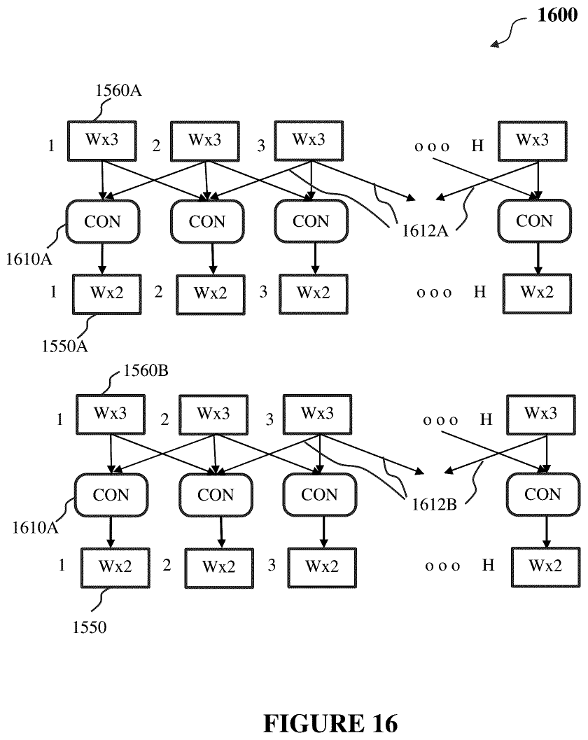

Referring to FIG. 16, illustrates a tensor transform of a 3×3 convolution computation of tensor image slices 1560A (1 . . . H), 1560B (1 . . . H) where there is dependency data 1612A, 1612B between the convolution computation 1610A and data in adjacent slices. A slice can be one or more rows (not shown). This dependency data can include the row above and the row below the slice that is subject to tensor transform convolution or other transform dependency data. For larger convolutions or other transforms, this dependency data can include additional rows that are extendable to N dimension.

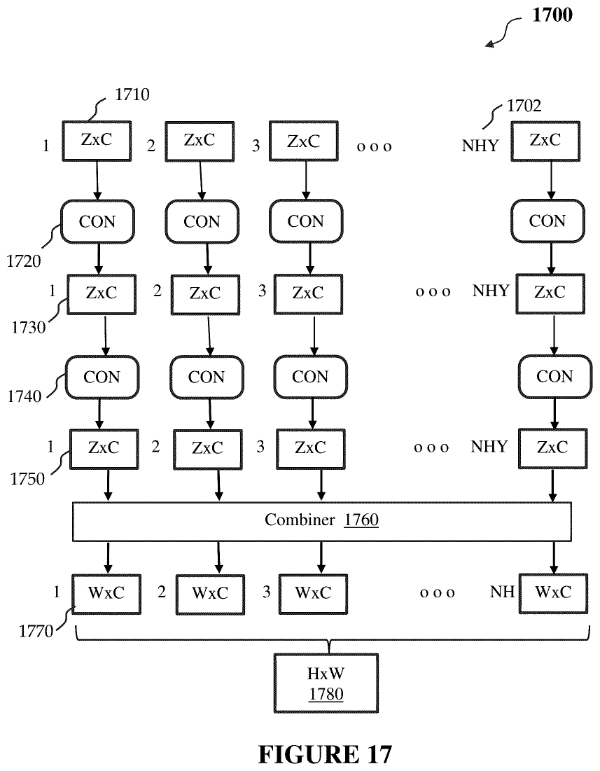

Referring to FIG. 17, illustrates the case where the image width times the number of channels, W×C, is too large for the best utilization of the system's processors and the processor system memory. Additionally, FIG. 17 is directed at reducing the size of the tensor to be processed by segmenting each row of the sliceable tensor. For example, if the image width is 4096 pixels, then three times this memory is required for each row of the image. Further, having multiple processors working on this one row can be difficult. Thus, the row with width “W” is divided into segments of width “Y” and “Z.” Thus, where the tensor transform is a 1×1 convolution, Y×Z=W. The numbering “NHY” indicates the row number and segment number. NY is the segment number where N is a batch number and the Y is the new column dimension. H is the row number. The data for each of these tensor slice data segments 1710 is processed by a tensor transform computation 1720, creating a tensor segment results 1730. The tensor segment result 1730 is again transformed 1740 into the tensor segment results 1750.

The combiner 1760 assembles the tensor segment results into output tensor slices of W×C (1 . . . NH) 1770. Note, that this processing structure works only because there is not any dependency data between the segments Z×C (1 . . . NHY) for a 1×1 convolution. The output tensor slices 1770 (1 . . . NH) resulting from the convolution can further be assembled into an output image 1780, also referred to as a final tensor result 1780.

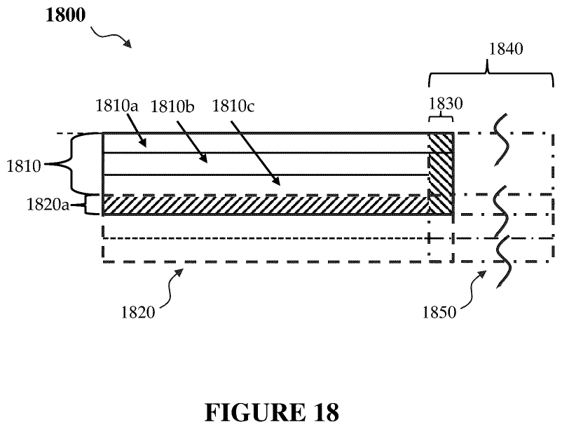

FIG. 18 illustrates the relationship between a tensor slice segments 1800 when the tensor transform has dependency data that can extend beyond the tensor slice segment. The tensor slice segment 1810 can include multiple rows of data 1810a, 1810b, and 1810c is the slice segment 1810 over which a tensor transform computation is to be performed. The slice segment 1820 is below the tensor slice segment 1810. Tensor slice segment 1850 is on the right and below of the tensor segment 1810. Because a transform, a 3×3 convolution, for example, has data dependencies that cross into adjacent tensor segments, dependency data is needed from adjacent slices to perform the convolution computation on the tensor slice 1810. For a 3×3 convolution, more than three rows are required. For convolution computation the row 1820a below tensor slice row 1810c is required. Additionally, column dependency data 1830 from the tensor slice 1840 and 1850 is required. Additional convolutions or other tensor transforms may require further rows.

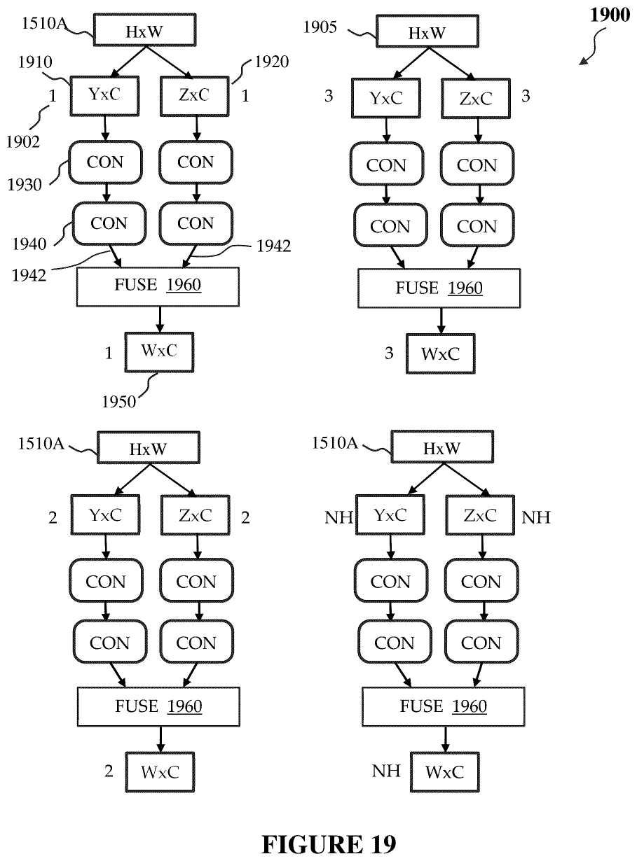

FIG. 19 illustrates the tensor transform 1900 of two convolution computations outputs generated from a segment of a slice of an input tensor 1510A. Referring to FIG. 15A, the input tensor slice or slice segment 1910, 1920 (1 . . . NH) can be from a multichannel image 1510A or other sliceable tensor. The slice or slice segment 1910, 1920 (1 . . . NH) can be the data from one or more rows 1540A (1 . . . H) of the tensor 1510A.

In one aspect of the invention, the tensor transforms can include one or more convolutions, but other transforms including but not limited to attention transforms are contemplated. As shown in FIG. 19, the two tensor transforms are two convolution computations, CONs 1930 and 1940. The tensor slices input into the convolutions 1930 and 1940 here are represented as “Y×C” or “Y” 1910 and “Z×C” or “Z” 1920. The tensor slice segments can include dependency data, which are overlaps with adjacent slice segments. The dependency data is caused by the tensor transforms, here CON 1930, 1940, having data dependencies that extend beyond a slice segment. Thus, the slice segments “Y” and “Z” can contain more data than the initial slice segment. The initial slice segment is also referred to as tensor slice data. This extra data is data from adjacent slice segment rows and columns.

The objective of the processing flow 1900 is to generate output tensor slices “W×C”, also referred to as final tensor outputs, 1950 (1 . . . NH). These final tensor outputs will be identical to the corresponding portion of the input tensor 1510A transform generated from 1510A in FIG. 15A if the input tensor was processed, as a whole, by two convolutions. However, tensor slice data with dependency data “Y” 1910 and “Z” 1920 is required to compute the tensor segment results or slice output results 1942. This occurs when the “Y” 1910 and “Z” 1920 convolutions computations 1930 and 1940 have data dependencies outside the tensor slice data. Thus, if the input source is a slice of “W” or a segment of “W” the of input tensor, “Y” needs to incorporate additional dependency data for a proper convolution computation of “W” 1950. The dependency data is required because the tensor transform, as shown as two convolutions 1930 and 1940 can create data dependencies that extend beyond tensor slice of “W” columns. This dependency data can overlap the adjacent segments and adjacent slices above and below as shown in FIG. 18. Thus, the slice “Y,” for example on an image, will require additional input tensor data that is outside of the input tensor slice of “W” columns.

For example, two 3×3 convolutions require two extra rows of data from an input tensor, an image, one for the first convolution and one for the second convolution. Further, if the slice is divided into multiple slice segments, for a proper convolution computation, two columns of data are required from the adjacent slice segments.

The extra data is generated as a byproduct of the tensor transform computation 1930, 1940 and the dependency data needs to be removed to construct an output tensor slice 1950, the transformed input tensors 1910, 1920. Further, transformed segment slices need to be assembled to form a final tensor result. This extra data is a result of the dependency data that extends beyond the input tensor slice. This dependency data can be above, below, and adjacent to the input tensor slice or slice segment, segments 1910 and 1920 as shown in FIG. 8. The result of the tensor transforms, the two convolutions 1930 and 1940, are to generate a tensor segment result 1942.

The fusion function (FUSE 1960) removes the dependency data and any unneeded computational byproducts from the tensor segment results 1942. Upon fusing 1960, the remaining data is a tensor segment output or an output tensor slice 1950 that results from the two convolution functions 1930, 1940 on the tensor slice data. This output tensor segment or slice segment 1950 will be identical to that output generated if the entire input tensor was processed by the transforms and a slice extracted from the results. The tensor segment outputs are combined into a complete slice, also referred to as an output tensor slice 1950. This process is repeated for each slice. generating a set of output tensor slices referred to the final tensor outputs 1950 (1 . . . NH). In the final step, the final output tensor slices can be combined into a final tensor result, as shown in 1780-FIG. 17.

### Slicing Attention Operations

One definition of Attention processing, as related to neural network and machine learning is found on the Internet at “Wikipedia en.wikipedia.org/wiki/Attention (machine learning)”:
“Attention is a machine learning method that determines the relative importance of each component in a sequence relative to the other components in that sequence. In natural language processing, importance is represented by “soft” weights assigned to each word in a sentence. More generally, attention encodes vectors called token embeddings across a fixed-width sequence that can range from tens to millions of tokens in size.
Unlike “hard” weights, which are computed during the backwards training pass, “soft” weights exist only in the forward pass and therefore change with every step of the input. Earlier designs implemented the attention mechanism in a serial recurrent neural network language translation system, but the later transformer design removed the slower sequential RNN and relied more heavily on the faster parallel attention scheme.
Inspired by ideas about attention in humans, the attention mechanism was developed to address the weaknesses of leveraging information from the hidden layers of recurrent neural networks. Recurrent neural networks favor more recent information contained in words at the end of a sentence, while information earlier in the sentence tends to be attenuated. Attention allows a token equal access to any part of a sentence directly, rather than only through the previous state.”

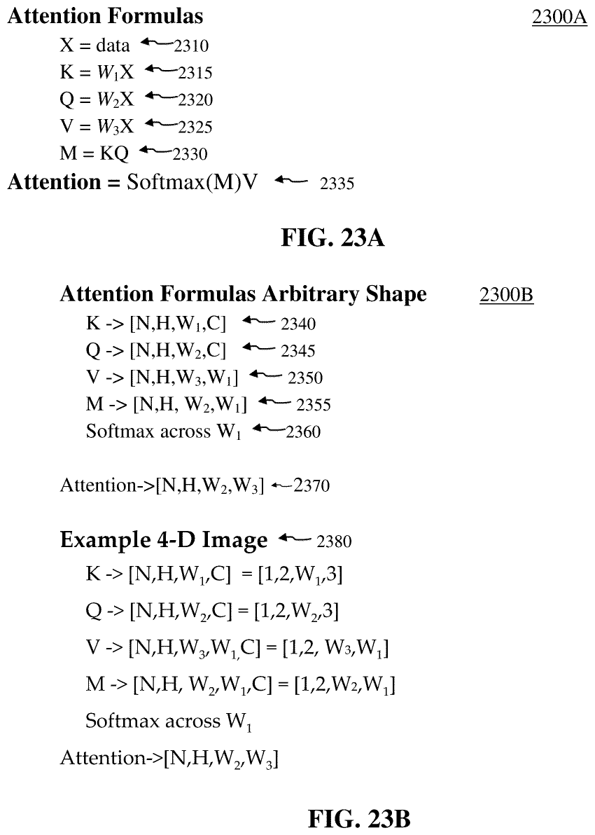

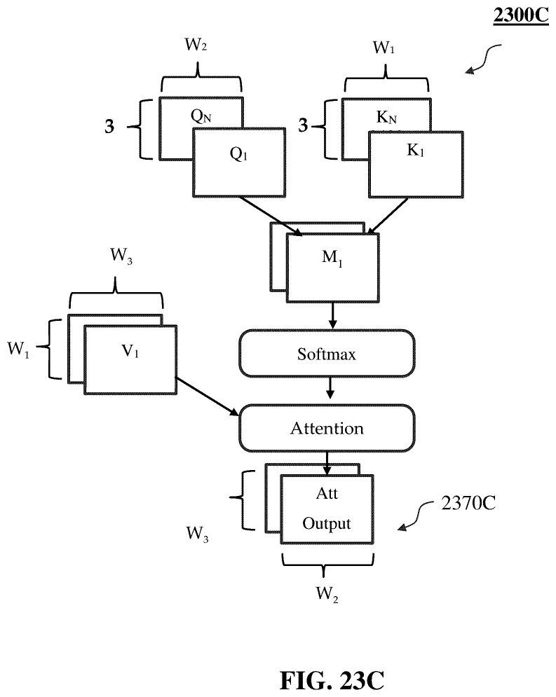

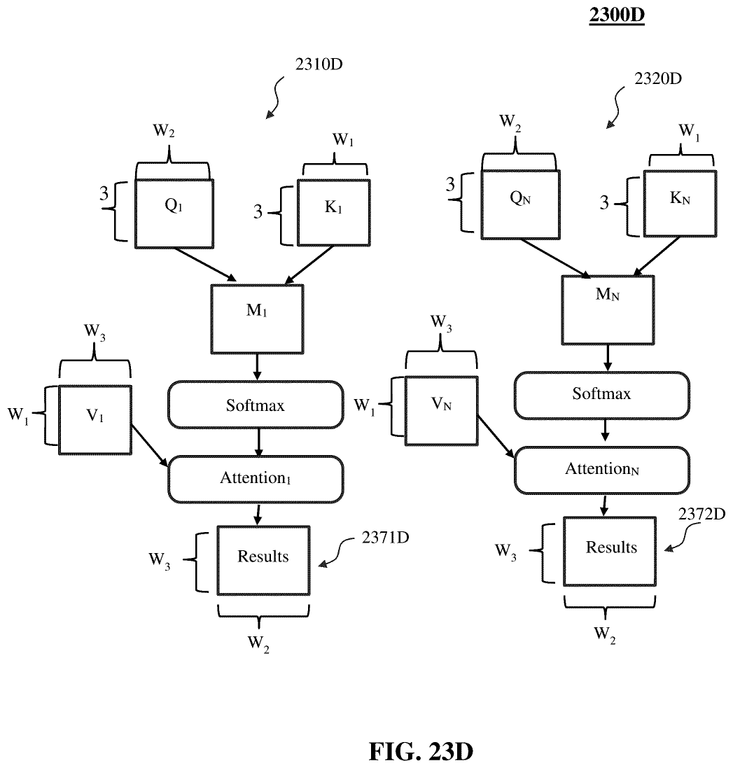

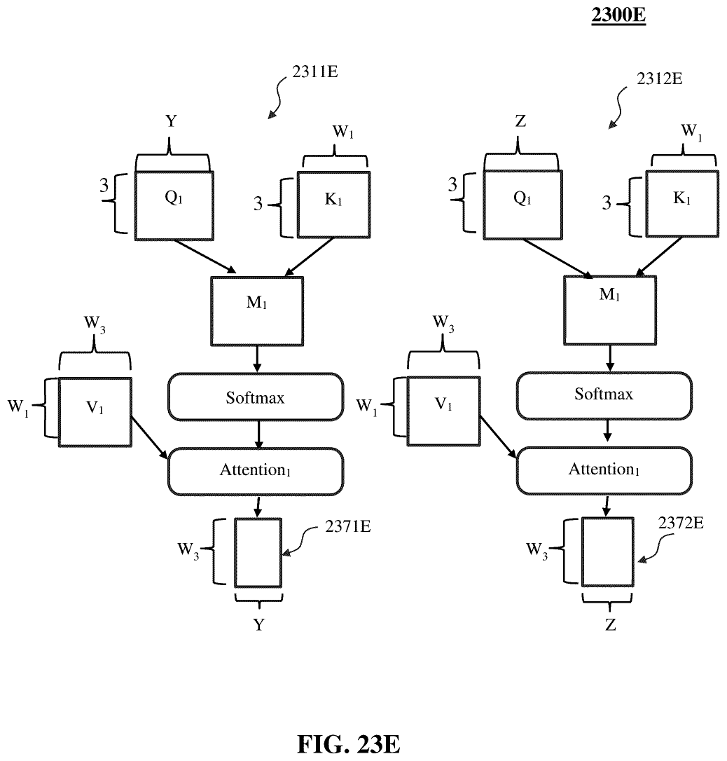

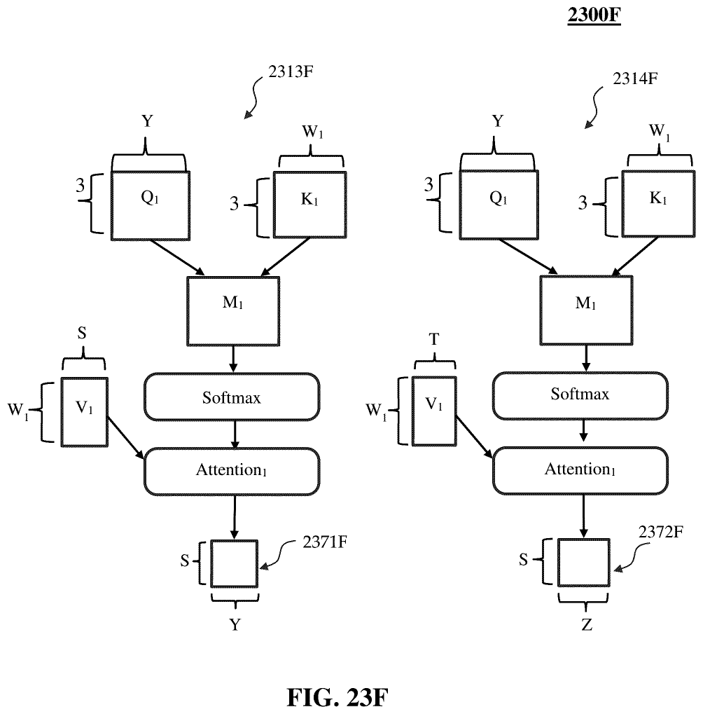

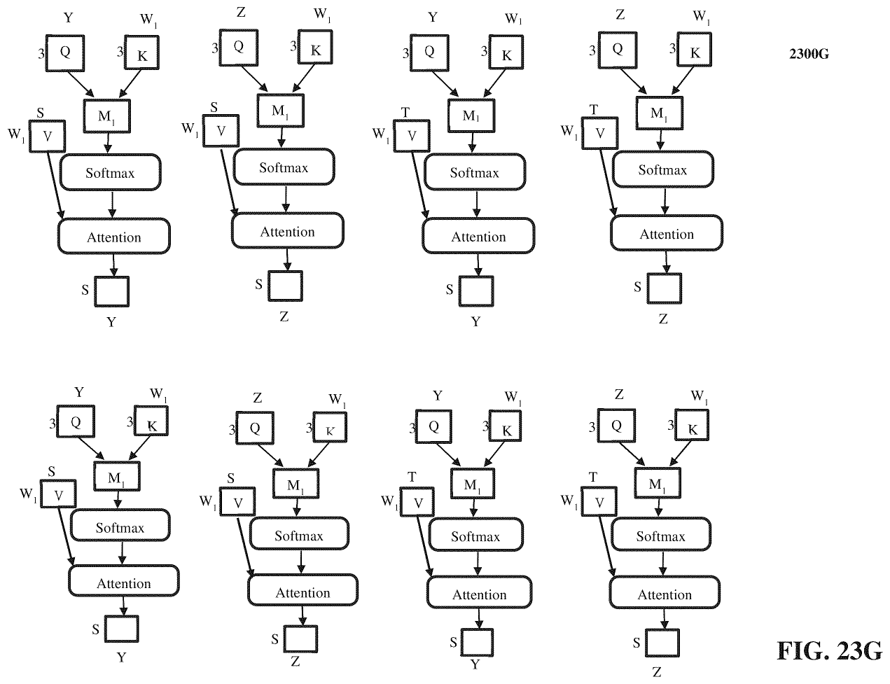

Attention can also be applied to other types of tensors. For images, attention can be related to identifying features within an image. Attention processing can incorporate matrix multiplication resulting in large matrices. However, the matrix processing operations can be broken into slices optimized for processor memory utilization and utilize the computational cores found in a NPU or other processor configured for neural processing to tensor processing. Referring to FIG. 23A a general equation for attention is for attention is shown and in FIG. 23B an attention equation for a 4-D image is shown.

### LLM Attention Processing Overview

At a high level, Large Language Models (LLMs) transform machines are generally built using a number of transformer layers. The job of the LLM is to predict the next token in a sequence of tokens. A token roughly corresponds to a word, but sometimes a word might translate to multiple tokens. The sequence of tokens that make up the prompt are fed into the LLM; then the LLM starts generating its answer one token at a time. After a token is generated, it is fed back into the LLM so that the LLM knows what tokens it has already generated.

Within the LLM, the token is mapped into a long list of numbers known as an embedding (e.g. 8192 numbers). This embedding is then mapped in various ways into other long lists of numbers. These are known as activations.

A transformer layer is itself made up of a number of layers, the most important of which are the Multi-Headed Attention Layer and the Fully-Connected layer.

The Multi-Headed Attention layer's job is to relate the current input token to the previous tokens the LLM has seen and has generated. To make this task practical, there is a limit on how far the attention goes back into the past. This is known as the context window. The Multi-Headed Attention starts by mapping the input token's embedding into three different activations called the Key (K), Value (V), and Query (Q). A POSITA (person of skill in the art of transformer neural networks) would know how to generate the inputs for the K, V, and Q matrices.

The next step is to perform a mathematical operation on the current Query and all the previous Keys and Values in the context window. Note that in order to do this, we need to either recalculate the previous Keys and Values for all the embeddings in the context window or store all the previous Keys and Values in the context window. The latter option is much more preferable, especially for long context windows. The store of the Keys and Values is called the KV cache.

The fully connected layer is a type of neural network that contains a large number of parameters (also known as weights) that process the input activation and turn it into an output activation. These parameters are learned during training and do not change during operation. These parameters form most of the parameters in the LLM.

The rate that a LLM can generate a response is limited by the time it takes to process a token through the whole network because each token depends on the previous token. So, processing must be performed serially with only one new token for the stream, being worked on at any one time.

To increase the throughput of the LLM we use a technique called batching, where the LLM processes multiple streams at once. So, the LLM can handle queries from multiple users at once. Thus, although the rate of each single stream is not increased, the total rate at which tokens are generated is increased by the batch size.

If we look at the batches in the Feed Forward Network part of the LLM, we see that all the batches use the same parameters. Thus, there is no extra cost in terms of memory bandwidth to increase the batch count. The extra batches consume processing power, but it is possible to provide sufficient processing power for quite high batch counts.

The KV cache, however, does have to store all the values independently for all batches. Thus, the size of the KV cache needed is directly proportional to the batch count. As the whole of the KV cache must be read for each batch's worth of tokens generated, this increase in batch size also increases the memory bandwidth needed.

So, for high batch counts, we require large KV caches, so require large high bandwidth memories. In contrast, the Feed Forward Network requires lower bandwidth. Thus, in order to build a system that makes optimal use of memory bandwidth, we place the KV cache into a high bandwidth (and high cost) memory and the parameters into a lower bandwidth (and lower cost) memory. These two types of memories are connected to different chips, and then the work is distributed across those chips in an interleaved manner as the processing moves from Attention to Feed Forward as each transformer layer is processed.

This technique is generally applicable for any AI task where there is memory bandwidth that is independent of batching mixed with memory bandwidth that depends on batching. It allows an optimal solution to be built, maximizing the batching while balancing the memory cost of each part of the system independently.

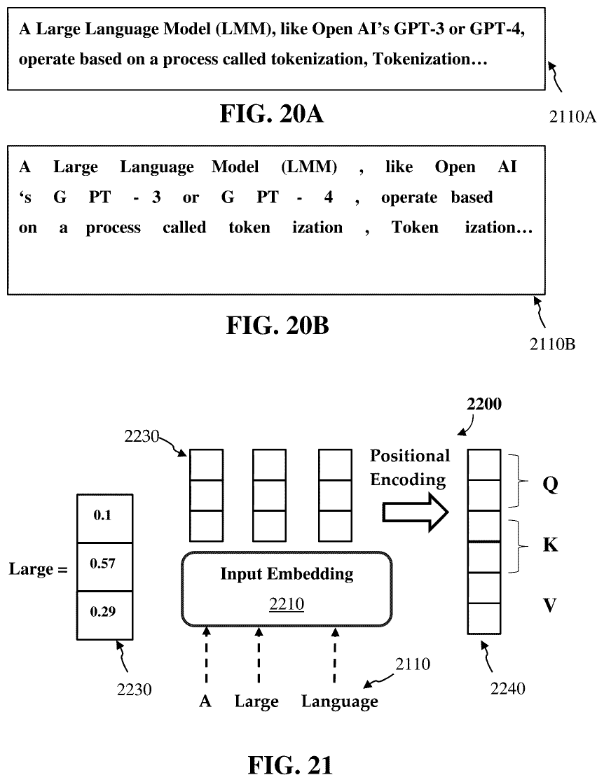

FIG. 20A shows “a sentence” 2110A before tokenization for input to a LLM Transformer. The sentence such as the one shown in FIG. 20A can be input into a Transformer Machine based on an attention mechanism after tokenization. Example of Transformer Machines include chat bots like ChatGPT-3 and ChatGPT-4.

FIG. 20B shows the sentence 2110A after being tokenized. Tokens 2110B are input into a Transformer Machine based on an attention mechanism after tokenization. Some words can become a token.

FIG. 21 shows the encoding 2200 of tokens 2110B into a word-embedded layer 2240. The word embedded layer 2240 encodes a representation of the tokens into numbers 2230. The embedded layer 2240 numbers includes a vector representation of the word and positional information of the tokens.

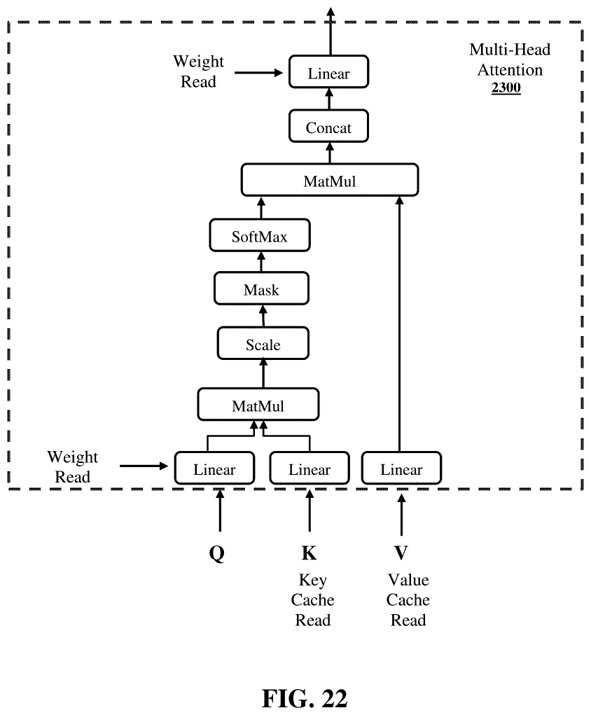

FIG. 22 shows the processing components of a multi-headed attention model 2300. In the shown embodiment, the attention mechanism generates self-attention where the model provides an association between each token with each of the other tokens in the input. The inputs to the first “Linear” layer are the Q, K, and V vectors. These represent the Query, Key, and Value inputs. The query and key undergo a dot-product multiplication to generate a scores matrix. The score metric determines how much focus should be put on other input words. Then, the scores get divided down by the dimension of the keys. This step is performed to prevent exploding gradients. Next, a SoftMax is performed on the normalized scores to generate probability values between zero and one. Next, the attention weights are multiplied by V, the value.

To make the model into a multi-headed computation, the Q, K, and V vectors need to be split into multiple vectors. Each of the vectors go through the same self-attention process individually. Each self-attention process is called a head. Each head generates an output vector which are concatenated into a single vector before going into a linear layer. In theory, each head would learn something different, therefore giving the encoder model more representation capability.

Referring to FIG. 23A, the formulas for attention processing 2300A are shown. “X” 2310 is the input data matrix. “X” 2310 can be the same for each of the equation but also can be different depending on the algorithm. Note, that the dimension of “X” 2310 needs to be the same for each input. In one embodiment, the input data can be tokens of text input as is found in the processing of LLMs (Large Language Models). In other embodiments, the input “X” 2310 can be an image or higher dimensional representations. For attention processing on or a multichannel image. “K” 2315 is the matrix multiplication of the weight matrix W₁ with then input data matrix “X” 2310. “Q” 2320 is the matrix multiplication of the weight matrix W₂ with then input data matrix “X” 2310. “V” 2325 is the matrix multiplication of the weight matrix W₃ with then input data matrix “X” 2310. “M” 2330 is the matrix multiplication of “K” and “Q”. The K and Q normalization and transposes are omitted for clarity.

The “Attention” 2335 is the Softmax 2360 of the matrix multiplication of “M” and “V”. The matrices K, Q, and V are projections of the input matrix into a different dimension using W₁, W₂, and W₃. The “Softmax” Function 2360 is a mathematical function used in machine learning algorithms. It takes a vector of real numbers as input and transforms it into a probability distribution over multiple classes. The Softmax 2360 is taken over the W₁ dimension. Attention processing is a well know technique and a POSITA would understand the implementation of the Attention function.

FIG. 23B shows the matrix dimensions 2300B for an attention computation of a typical 4-D image model. K 2340 has the dimensions [N, H, W₁, C], “Q” 2345 has the dimension [N, H, W₂, C], “V” 2350 has the dimension [N, H, W₃, W₁], and “M” 2355 has the dimension [N, H, W₂, W₁]. One or more of the K, Q, V matrices can be an image tensor, a feature vector or feature tensor that can be processed from an image or from a language. These images, tensors, or feature vectors are not typically large images but can be smaller tensors, 3×3, 8×8, or 16×16 for example.

The dimensions for an example of attention processing based on a 4-D image 2380 are shown. In this case, the hidden dimension between K and Q is 3. The hidden dimensions between K and Q need to be of the same dimension. Shown are the processing flow for two rows in Q₁-Q_{N} and K₁-Q_{N} and two rows in the attention output 2370C.

For the example in FIG. 23C, the rows are independent throughout the entire block. Only a row of Qₙ, Kₙ, and Vₙ are required to generate a row of attention output 2370C. Thus, the row one from the Q₁, row one from the K₁, and row one from the V₁ matrix are all that are needed to compute row one for the attention output 2370C.

FIG. 23D shows each row 2310D and 2320D being independent computation paths independent of the other rows. Thus, the processing of each row can occur independently. Accordingly, the input data X for determining each row or Q, K, and V can be generated independently, sent to a different processor, and the data and results reside in different processor memory.

Additionally, the W₂ dimension of the Q matrix is independent between the Q columns. Thus, the attention processing can be further split along the W₂ dimension. The processing of the split along W₂ is shown with two processing paths as shown in FIG. 23E. The first processing path 2311E provides processing of Y columns and the second processing path 2312E provides processing of Z columns where Y+Z=W₂.

Further evaluation of the processing path 2311E of FIG. 23E, shows that the W₃ columns of the Value matrix V are independent in relation to computing a column of the attention output 2371E, 2372E. Because of the independent between the columns in V, the processing paths 2311E can be further broken down into the two processing paths shown in FIG. 23F. The first processing path 2313E provides processing of S columns and the second processing path 2314F provides processing of T columns where S+T=W₃.

Note, that the W₁ dimension can not be split in the manner described above because the function “Softmax” needs the results of the K×Q matrix product column to compute the “Softmax” product. Thus, in one embodiment the K and/or V feature vectors can be divided when a “Flash Attention” function is used to compute a Softmax results to be applied to the divided portion of the value feature vector V. This embodiment is not shown in the figures.

Referring to FIG. 23G, the eight independent processing paths for processing attention is shown after dividing the rows, Q, and V feature vectors. The determined attention results from each processing path can be assembled to provide a final attention result. Additionally, each of the eight processing paths can receive a data packet with the image data needed for the attention processing. Further, each processing path can be assigned to a different processor.

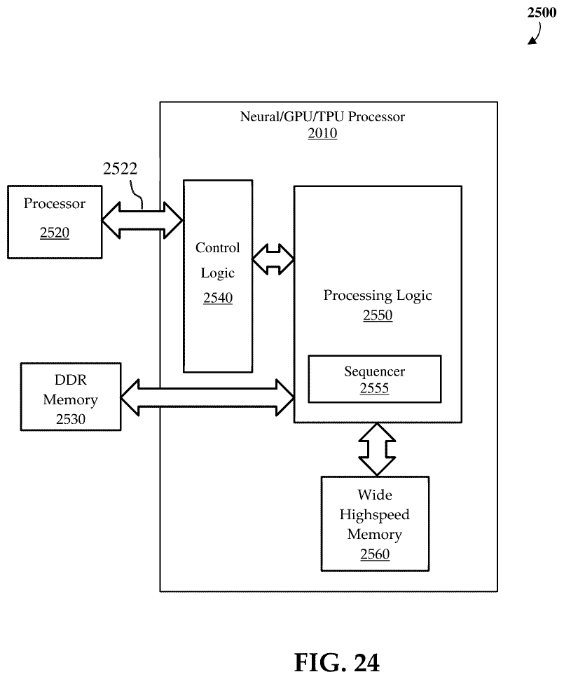

FIG. 24 is a block diagram of one embodiment of a multilayer neural network system 2000 suitable to implement the systems and methods disclosed herein. The system is comprised of a neural processor 2510, a processor 2520, and external memory 2530. The processor 2520 can provide overall configuration, neural network control, and results processing. The processor 2520 can be a general-purpose processor or a custom special-purpose processor. The processor can include local memory for storing and executing programs, I/O, and can be connected to a data bus 2522. The data can be coupled to the Neural/GPU/TPU processor 2510 system. The external memory 2530 can store intermediate layer tensors and layer weights, source tensors, transforms, and tensor slices.

The processor 2520 can provide configuration and high-level control for processing a multilayer neural network. The processor 2520 can be a digital signal processor, a microprocessor or other customized computational logic suitable for control and configuration of the above-mentioned functions.

The neural processor 2510 can include control logic 2540, processing logic 2550, and wide high-speed memory 2560 also referred to as on-chip memory. The control logic 2540 includes the microelectronics required to control the data flow from memory to the processing logic 2550. The sequencer 2555 can also provide control over the on-chip memory 2560 for the flow of tensor data to and from the processing logic 2550 and the on-chip memory 2560 and off-chip memory or external memory 2530.

The processing logic 2550 can include electronics for a matrix of multiply and accumulate logic configured to perform parallel matrix operations in support of the processing of a multilayer neural network.

The on-chip memory 2560 can be designed to include partitions and provide a wide memory path to and from the processing logic 2550. Further, a portion of the on-chip memory can be shared between Jobs and is referred to as shared memory. Additionally, the off-chip memory 2030 can be utilized as shared memory and can also be referred to as shared memory.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description. The scope of the claims should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim is still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. § 1.72(b), which requires that it allow the reader to quickly ascertain the nature of the technical disclosure. The abstract is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

What is claimed is:

1. A method of performing one or more tensor operations with a multi-step operation processing system in a memory efficient manner, said method comprising the stages of:
dividing a N-dimensional input tensor including X-rows and Y-columns into a set of tensor slices, the tensor slices consisting of one or more consecutive X-rows of said N-dimensional tensor;
for each tensor slice in said set of tensor slices; performing the substages of:
loading tensor slice data for a tensor operation,
loading dependency data from one or more adjacent tensor slice data based on the tensor transform dependencies,
executing said tensor operation on said tensor slice data, dependency data, and any saved intermediate results to generate tensor segment results,
fusing the tensor segment results thereby removing extra data resulting from the dependency data and tensor operation and forming a tensor segment output,
repeating said substages of loading, executing, and fusing until an output tensor slice from said multi-step operation processing system is complete; and
repeating said substages of loading and executing until final tensor outputs from said multi-step operation processing system is complete for said set of tensor slices.

2. The method of claim 1, further comprising combining said final tensor outputs for each said set of tensor slices into a final tensor result for said tensor.

3. The method of claim 1, wherein said tensor operation is a convolution computation.

4. The method of claim 1 wherein said tensor operation is more than one layer operation.

5. The method of claim 1, wherein the method extracts one or more feature from the image.

6. The method of claim 1 wherein said tensor slices comprise multiple rows of tensor data.

7. A system, comprising:
a processor; and
a memory communicatively coupled to the processor, the memory for storing instructions executable by the processor to perform a method, said method comprising the stages of:
dividing a N-dimensional input tensor including X-rows and Y-columns into a set of tensor slices, the tensor slices consisting of one or more consecutive X-rows of said N-dimensional tensor;
for each tensor slice in said set of tensor slices; performing the substages of:
loading tensor slice data for a tensor operation,
loading dependency data from one or more adjacent tensor slice data based on the tensor operation dependencies,
executing said tensor operation on said tensor slice data, dependency data, and any saved intermediate results to generate tensor segment results,
fusing the tensor segment results thereby removing extra data resulting from the dependency data and tensor operation and forming a tensor segment output,
repeating said substages of loading, executing, and fusing until an output tensor slice from said multi-step operation processing system is complete; and
repeating said substages of loading and executing until a final tensor output from said multi-step operation processing system is complete for said set of tensor slices.

8. The system of claim 7, further comprising the step of combining said final tensor outputs for each said set of tensor slices into a final tensor result for said input tensor.

9. The system of claim 7, wherein said processor is a NPU or TPU.

10. The system of claim 7, further comprising combining said final tensor outputs for each said set of tensor slices into a final tensor result for said tensor.

11. The system of claim 7, wherein said tensor operation is a convolution computation.

12. The system of claim 7, wherein said tensor operation is more than one layer operation.

13. The system of claim 1, wherein the method extracts one or more feature from the image.

14. The system of claim 7, wherein said tensor slices comprise multiple rows of tensor data.

15. A method of performing an attention computation on an input image tensor X by splitting the attention processing into stages of independent computations: the computations comprising the stages of:
dividing the input data X into image data-rows, input data X representing a four-dimensional image having H rows,
for each image-row, divide the attention processing into independent processing steps by;
dividing a query feature vector Q, the query feature vector Q having dimensions C by W₂, into a Y-query vector having dimensions C by Y, and a Z-query vector having dimensions C by Z;
for each of the Y query vector and the Z query vector,
dividing the value feature vector V, the value feature having the dimensions W₁ by W₃, into an S-value feature vector having dimensions W₁ by S, and a T-value feature vector having the dimensions W₁ by T thereby generating eight independent processing paths;
for each of the eight processing paths of the divided query feature vector Q and divided value feature vector V;
computing a column-slice of the Y query vector multiplication with a column-slice of a key feature vector K generating a column slice of matrix M;
computing a column-slice of the Z query vector multiplication with a column-slice of a key feature vector K generating a column slice of matrix M;
accumulating the Softmax determination of the column slice of M; and
for each of the eight processing paths
computing a column-slice of attention output based on the product of the row-slice of V and the accumulated softmax of M;

16. The method of claim 15, further including the step of assembling the column-slice of attention output to form an attention result.

17. The method of claim 15, wherein the dimension Y+Z=W₂.

18. The method of claim 15, wherein the dimension S+T=W₃.

19. A method of performing attention computation on a input tensor, the attention computation including a key tensor, query tensor, and value tensor, said method comprising:
generating a subset of the key tensor by reducing one of the dimensions of the key tensor;
generating an associated subset of the value tensor by reducing one of the dimensions of the value tensor;
generating an associated subset of the value tensor by reducing at least two dimension of the entire query tensor;
using the key tensor, value tensor, and query tensor, compute a plurality of subset output tensors wherein the plurality of subset of output tensors are reduced by at least tow dimensions.

20. The method of claim 19, wherein the method further comprises the use of convolutions to generate the key tensor, the value tensor, and then query tensor.

21. The method of claim 19, wherein the key tensor, the value tensor, and the query tensor are constants determined by training of a neural network.
